(19) United States
(12) Patent Application Publication
(10) Pub. No.: US 2026/0048625 A1
(43) Pub. Date: Feb. 19, 2026

(54) TRAILER COUPLING

(71) Applicant: ACPS Automotive GmbH, Ingersheim (DE)

(72) Inventor: Wolfgang Gentner, Steinheim (DE)

(73) Assignee: ACPS Automotive GmbH, Ingersheim (DE)

(21) Appl. No.: 19/291,895

(22) Filed: Aug. 6, 2025

(30) Foreign Application Priority Data
Aug. 15, 2024 (DE) 102024123336.2

(51) Int. Cl. B60D 1/06; B60D 1/54

(52) U.S. Cl. CPC B60D 1/06; B60D 1/54; B60D 2001/544

(57) ABSTRACT

In order to improve a trailer coupling, comprising a ball neck, which is movable between a working position and a rest position and which is connected at a first end to a pivot bearing unit and carries a coupling ball at a second end, wherein the ball neck is pivotable by means of the pivot bearing unit about a pivot axis between the working position and the rest position in order to execute a pivoting movement, and a rotation blocking device acting between a guide body and a pivot bearing body of the pivot bearing unit and having at least two rotation blocking units, each of which has a rotation blocking body, which is guided movably in a guide direction by means of a guide receptacle of the guide body and which is movable in the guide direction by a pushing surface extending transversely to the guide direction and provided on an actuating body, in such a way that it realizes an easy-to-implement securing of the actuating body in the rotation blocking positions, it is proposed that a blocking device is provided which comprises a blocking body which is movable into a securing position securing the actuating body in the rotation blocking positions and a standby position lying outside the securing position.

### CROSS-REFERENCE TO RELATED PATENT APPLICATION

The present disclosure relates to the subject matter disclosed in German application number 10 2024 123 336.2 of 15 Aug. 2024, which is incorporated herein by reference in its entirety and for all purposes.

### BACKGROUND OF THE INVENTION

The invention relates to a trailer coupling, comprising a ball neck, which is movable between a working position and a rest position and which is connected at a first end to a pivot bearing unit and carries a coupling ball at a second end, wherein the ball neck is pivotable about a pivot axis between the working position and the rest position by means of the pivot bearing unit in order to execute a pivoting movement, and a rotation blocking device acting between a guide body and a pivot bearing body of the pivot bearing unit and having at least two rotation blocking units, each of which has a rotation blocking body which is guided movably in a guide direction by means of a guide receptacle of the guide body and which is movable in the guide direction by a pushing surface provided on an actuating body and running transversely to the guide direction, wherein the rotation blocking bodies of all rotation blocking units are movable and can be acted upon in the guide direction by a movement of the actuating body in an actuating direction, and wherein the rotation blocking bodies of all rotation blocking units in the working position or the rest position can be brought into a rotation blocking position by movement in the guide direction and in this position each rotation blocking body comes into engagement with one of the at least two working position receptacles or one of the at least two rest position receptacles, in order to block a pivoting movement of the pivot bearing body and of the guide body about the pivot axis relative to one another, and wherein the rotation blocking bodies can be brought into a release position and in this position are disengaged from the respective working position receptacle or the respective rest position receptacle and release the pivoting movement between the pivot bearing body and the guide body, wherein in all provided relative pivot positions between the pivot bearing body and the guide body, apart from the working position and the rest position, a movement of the actuating body in the actuating direction and consequently also a force-loaded engagement of the rotation blocking bodies of each of the rotation blocking units in one of the working position receptacles or the rest position receptacles is blocked.

Proceeding from the known solutions, in accordance with an embodiment of the invention, provision is made to optimize their functions.

### SUMMARY OF THE INVENTION

In accordance with an embodiment of the invention, a blocking device is provided which comprises a blocking body which can be moved into a securing position securing the actuating body in the rotation blocking positions and a standby position lying outside the securing position.

The advantage of the solution according to the invention is thus to be seen in the fact that in this solution an easy-to-implement securing of the actuating body in the rotation blocking positions can be realized.

In particular, the actuating body is secured in the rotation blocking positions both in the working position and in the rest position.

It is particularly favorable if the blocking body is guided on, in particular in, the guide body of the pivot bearing unit.

In particular, it is advantageous if the blocking body is guided in a guide arranged on the guide body.

With regard to the arrangement of the guide for the blocking body on the guide body, no further details have yet been provided.

For example, one advantageous solution provides for the guide for the blocking body to be arranged in a wall region of the guide body adjacent to the actuating body.

In particular, this wall region of the guide body is located between the actuating body on the one hand and on the pivot bearing body, in particular in an end flange of the latter, on the other.

The movements of the blocking body in the guide could be realized in a wide variety of ways.

However, a particularly advantageous structural solution provides for the blocking body to be movable in the guide in a direction approximately parallel to the pivot axis.

Furthermore, it is preferable for the blocking body to engage in a receptacle in the actuating body in the respective securing position in order to secure it in the rotation blocking position.

Furthermore, no further details have been provided with regard to the standby position.

Thus, an advantageous solution provides for the blocking body in the standby position to be positioned adjacent to the actuating body.

Furthermore, with regard to the simplicity of the solution to be implemented, it has proven to be advantageous if the blocking body in the securing position engages with one end in the receptacle of the actuating body, starting from and guided by the guide.

Furthermore, it has proven to be advantageous if the blocking body can be fixed in the securing position by an actuating device.

An actuating device of this kind can be formed in a wide variety of ways.

A particularly favorable solution is for the actuating device to comprise a camming guide and a cam follower which can be moved by the latter and which is coupled to the blocking body.

Preferably, the cam follower can be moved approximately parallel to the pivot axis by the camming guide.

Furthermore, it has proven to be advantageous if the camming guide can be moved in a plane transverse to the pivot axis.

It is particularly advantageous if the camming guide can be moved by an actuating device.

For example, the actuating device is configured in such a way that it comprises a body that carries the camming guide and can be moved in rotation relative to the cam follower.

In particular, it is provided that the camming guide has at least one camming path acting on the cam follower.

It is particularly advantageous if the camming guide has two camming paths acting on the cam follower and guiding it between them, as this makes it possible to position the cam follower—if necessary—in a defined manner at all times.

In particular, this makes it possible for both camming paths together to fix the cam follower in a position that defines the securing position.

Furthermore, an advantageous solution provides that a first camming path comprises a path portion that can move the cam follower from the position defining the securing position into a position defining a standby position.

Furthermore, it is advantageous if a second camming path has a path portion which moves the cam follower from the position corresponding to the standby position to a position resiliently loading the cam follower towards the securing position.

This means that the cam follower is resiliently loaded by this path portion in order to move to the securing position, provided this is possible due to the position of the actuating body.

Furthermore, in the case of the two camming paths, it is provided that the first camming path is effective by a movement of the camming guide in a first rotational direction and the second camming path is effective by a movement of the camming guide in a rotational direction opposite to the first rotational direction.

Furthermore, it is preferably provided that the actuating device can be driven by an actuating unit for the rotation blocking device, in particular the actuating device is coupled to the actuating unit.

This solution has the great advantage that the actuation of the blocking body can be coupled directly with the actuation unit for the rotation blocking device.

In particular, it is provided that the camming path is arranged on a rotatable body of a planetary gearing of the actuating unit for the rotation blocking device.

In particular, the rotatable body of the planetary gearing is a ring gear of the latter, which carries the camming path on the circumferential side.

In addition, it is preferable for the blocking device to have a sensor that detects the positions of the blocking body.

The sensor is configured in such a way that it detects the securing position and the standby position by being acted on in different ways.

In particular, the cam follower is coupled to the blocking body by means of a transmission element so that the blocking body follows all movements of the cam follower.

Furthermore, the transmission element is preferably coupled to a sensor actuating element, which actuates the sensor.

A further advantageous embodiment of the invention provides that blocking surfaces extend between the working position receptacles and the rest position receptacles, against which blocking surfaces the rotation blocking bodies are placeable and from which the working position receptacles and the rest position receptacles extend, that the rotation blocking units and the working position receptacles and the rest position receptacles are arranged around the pivot axis at angular spacings from one another in such a way that, in all provided pivot positions of the pivot abutting body and of the guide body relative to one another, apart from the working position and the rest position, the rotation blocking body of at least one of the rotation blocking units is opposite one of the blocking surfaces and thus this blocking surface, in particular when a force is applied to the actuating body, blocks a movement of the actuating body in the actuating direction and consequently also a force-applied engagement of the rotation blocking bodies of each of the rotation blocking units in one of the working position receptacles or rest position receptacles.

The advantage of the solution according to the invention is thus to be seen in the fact that the fixing of the actuating body in the release position can be realized in a simple and reliable manner by means of the already existing rotation blocking bodies and that, in addition, a significant noise reduction occurs during the transition of this trailer coupling from the release position to the rotation blocking position of the rotation blocking bodies, since the rotation blocking bodies can slide easily from the blocking surfaces into the receptacles.

The solution according to the invention is also solved in a trailer coupling of the type described at the outset, as an alternative or in addition to the solution described above, in that the rotation blocking units are arranged at angular spacings around the pivot axis to form a rotation blocking configuration, in that the working position receptacles and the rest position receptacles for forming a respective receptacle configuration for the working position and the rest position are arranged at the same angular spacing around the pivot axis as the rotation blocking units, in that the rotation blocking configuration and the receptacle configuration of the working position receptacles in the working position or of the rest position receptacles in the rest position are congruent with one another, so that the rotation blocking bodies can engage in the working position receptacles or rest position receptacles, and in that the angular spacings between the rotation blocking units of the rotation blocking configuration and the angular spacings between the working position receptacles or rest position receptacles of the receptacle configurations are selected in such a way that the rotation blocking configuration and the receiving configurations are only congruent with one another in the working position or the rest position and thus only in these allow a transition of the actuating body from the release position to the rotation blocking position, while in the other pivot positions of the pivot bearing body and the guide body relative to one another a transition of the actuating body from the release position to the rotation blocking position is not possible.

Alternatively or in addition to the solutions according to the invention described above, a further advantageous solution provides that the angular spacings of at least one of the rotation blocking units to the rotation blocking units arranged adjacent in a direction of revolution about the pivot axis and to the rotation blocking units arranged adjacent in the opposite direction to this rotational direction are unequal, and that in the working position the working position receptacles are arranged in such a way that the rotation blocking bodies of each of the rotation blocking units are configured to be brought into engagement with one of the working position receptacles, that in the rest position the rest position receptacles are arranged in such a way that the rotation blocking body of each of the rotation blocking units are configured to be brought into engagement with one of the rest position receptacles, and that in all pivot positions of the pivot abutting body and the guide body relative to one another, which are provided for operation and which lie outside the working position and the rest position, the rotation blocking body of at least one of the rotation blocking units lies opposite a blocking surface located between the working position receptacles and the rest position receptacles and the blocking surface blocks a movement of the actuating body from the release position into the rotation blocking position, in particular when force is applied to the actuating body.

Starting from equal angular spacings, the inequality of the angular spacings amounts, for example, to at least one deviation from equal angular spacings in the order of magnitude of half the angular range over which each of the receptacles extends, preferably up to the angular range over which each of the receptacles extends.

The advantage of all the above-mentioned solutions according to the invention is that they provide a structurally simple solution for holding the actuating body in the release position and only allowing it to move into the rotation blocking position in the working position and in the rest position, wherein in particular the rotation blocking bodies already available for the rotation blocking device can advantageously be used.

In the context of the solution according to the invention, it has proven to be particularly advantageous if the number of rotation blocking units corresponds to the number of working position receptacles and the number of rest position receptacles.

Furthermore, in order to obtain a spatially compact solution, in particular in the direction of the pivot axis, it is advantageous if the rotation blocking bodies of all rotation blocking units are configured and arranged symmetrically to a geometric plane running perpendicular to the pivot axis and intersecting it.

A particularly advantageous solution is for the blocking surfaces to face the rotation blocking bodies of the rotation blocking units, in particular transversely, preferably perpendicular to the guide direction, so that the rotation blocking bodies can be moved over the blocking surfaces with little or virtually no resistance to movement when they come into contact with them.

It is particularly advantageous if the blocking surfaces run in a defined radius around the pivot axis, so that during the pivoting movement the rotation blocking bodies abutting on these blocking surfaces do not perform any additional radial movement relative to the pivot axis.

Furthermore, it is advantageously provided that the blocking surfaces extend up to the opening edges of the working position receptacles and the rest position receptacles and merge into these.

In particular, it is preferably provided that the opening edges of the working position receptacles and the rest position receptacles are at the same radial spacing from the pivot axis as the blocking surfaces, so that the rotation blocking bodies in contact with the blocking surfaces can be moved beyond the opening edges into the receptacles without additional resistance to movement, as would occur, for example, if the opening edges were at different spacings from the pivot axis in relation to the spacing of the blocking surfaces from the pivot axis.

In particular, this solution also has the advantage that it enables a simple transition of the pivot bearing body from the working position to a pivot position without resistance to movement, since in this case the rotation blocking bodies can also leave the working position receptacles and the rest position receptacles substantially without resistance to movement by means of the opening edges and can move in the direction of the blocking surfaces.

It is particularly advantageous if at least one of the rotation blocking bodies of the rotation blocking units abuts against one of the blocking surfaces during a relative pivoting movement between the pivot bearing body and the guide body in the direction of the working position, in particular during the pivoting movement from the rest position to the working position, in particular by the action of the actuating body, wherein the application of force is effected, for example, by retraction receptacles provided in the actuating body for the release position of the rotation blocking bodies, which retraction receptacles act on the rotation blocking bodies with surfaces running transversely to the guide direction.

In particular, it is advantageous if the rotation blocking bodies abut in a force-loaded manner against the blocking surfaces before reaching the working position and then enter the receptacles abutting in a force-loaded manner against the opening edges of the receptacles, so that the noise level can be kept as low as possible when the rotation blocking bodies move from the release position to the rotation blocking position, in contrast to a case in which the rotation blocking bodies initially abut against the blocking surfaces with play, are then applied with force to the blocking surfaces and then enter the working position receptacles from the blocking surfaces or the case in which the rotation blocking bodies move into the working position lying with play to the blocking surfaces and experience the application of force in the working position in order to enter the working position receptacles.

With regard to the configuration of the working position receptacles, it is particularly advantageous if the working position receptacles extend from the blocking surfaces in the guide direction, in particular with at least one component in the radial direction to the pivot axis, so that the rotation blocking bodies do not experience any additional deflection when moving in the guide direction when entering the working position receptacles.

It is particularly advantageous if at least one of the rotation blocking bodies of the rotation blocking units abuts against one of the blocking surfaces during a relative pivoting movement between the pivot bearing body and the guide body in the direction of the rest position, in particular during the pivoting movement from the working position to the rest position, in particular by the action of the actuating body, wherein the application of force is effected, for example, by retraction receptacles provided in the actuating body for the release position of the rotation blocking bodies, which retraction receptacles act on the rotation blocking bodies with surfaces running transversely to the guide direction.

In particular, it is advantageous if the rotation blocking bodies abut in a force-loaded manner against the blocking surfaces before reaching the rest position and then enter the rest position receptacles abutting in a force-loaded manner against the opening edges of the rest position receptacles, so that the noise level can be kept as low as possible when the rotation blocking bodies move from the release position to the rotation blocking position, in contrast to a case in which the rotation blocking bodies initially abut against the blocking surfaces with play, are then applied with force to the blocking surfaces and then enter the rest position receptacles from the blocking surfaces or the case in which the rotation blocking bodies move into the rest position lying with play to the blocking surfaces and experience the application of force in the rest position in order to enter the rest position receptacles.

With regard to the configuration of the rest position receptacles, it is particularly advantageous if the rest position receptacles extend from the blocking surfaces in the guide direction, in particular with at least one component in the radial direction to the pivot axis, so that the rotation blocking bodies do not experience any additional deflection when moving in the guide direction when entering the rest position receptacles.

Furthermore, no further details have been provided with regard to the alignment of the working position receptacles and the rest position receptacles and the blocking surfaces relative to the guide sleeve.

An advantageous solution is that the working position receptacles and the rest position receptacles and the blocking surfaces are arranged facing the guide sleeve, so that a deflection-free movement of the rotation blocking body in the direction of the blocking surfaces or in the direction of the working position receptacles and the rest position receptacles can take place.

In general, the pivot bearing body and the guide body are pivotable relative to each other about the pivot axis.

However, a particularly favorable structural solution is that the guide body is part of the pivot bearing unit.

Furthermore, with regard to the configuration of the guide body, it is envisaged that all guide receptacles for the rotation blocking bodies of the rotation blocking units are arranged in the guide body.

Furthermore, it is expedient if the guide direction runs with at least one component in the radial direction to the pivot axis, so that the rotation blocking bodies are moved at least with one component in the radial direction to the pivot axis between the rotation blocking position and the release position and thus no exclusive movement of the rotation blocking bodies in the direction of the pivot axis takes place in order to move them between the rotation blocking position and the release position.

A particularly favorable structural solution is that the guide body has a guide sleeve with guide receptacles for the rotation blocking bodies of the rotation blocking units and that, in particular, the rotation blocking bodies are guided by the guide body which adjoins the pivot bearing body in the radial direction.

In conjunction with the explanation of the above exemplary embodiments, no further details were given as to how the pivot bearing body should be pivotably mounted on the pivot bearing unit.

For example, a bearing provided for this purpose could be provided on the pivot bearing unit, which bearing is independent of the guide body.

However, it is particularly simple in terms of structure if the guide body has a pivot bearing for the pivot bearing body, i.e., either carries a pivot bearing for the pivot bearing body or itself forms a pivot bearing for the pivot bearing body with an outer surface.

No further details have been provided with regard to the movement of the actuating body in relation to the guide body.

Thus, an advantageous solution provides for the actuating body to be movably guided relative to the guide body.

In this case, the actuating body could be movable relative to the guide body in the direction of the pivot axis between the rotation securing position and the release position in order to move the rotation blocking bodies in the corresponding positions.

A solution that is particularly optimized in terms of the spatial requirement provides for the actuating body to be arranged rotatably about the pivot axis and, in particular, to have wedge surfaces extending over an angular range about the pivot axis and varying in the direction parallel to the guide direction, preferably combined with retraction receptacles.

In addition, no further details were provided with regard to the arrangement of the receptacles and the blocking surfaces.

Thus, an advantageous solution provides that the receptacles and the blocking surfaces are arranged on the pivot bearing body.

Furthermore, a structural solution is particularly favorable in terms of absorbing the acting forces if the actuating body is surrounded by the guide body and, in particular, if the pivot bearing body engages around the guide body.

No further details have been provided with regard to the arrangement of the rotation blocking bodies relative to the actuating body.

In principle, the rotation blocking bodies could be arranged in such a way that they are surrounded by the actuating body.

For the spatial structure of the trailer coupling according to the invention, it has also proven to be advantageous if the rotation blocking bodies are arranged around the actuating body.

It has proven to be particularly advantageous in terms of structure if the pivot bearing body forms an outer body which surrounds the guide body on the outside and which is arranged non-displaceably relative to the pivot bearing unit in the direction of the pivot axis, and if, in particular, the pivot bearing body forms an outer body which surrounds at least a partial region of the rotation blocking unit on the outside and which is arranged such that it cannot be displaced relative to the guide body in the direction of the pivot axis, so that the pivot bearing body does not perform any movement in the direction of the pivot axis during the transition of the rotation blocking bodies from the rotation blocking position to the release position and vice versa, but can be arranged non-displaceably in the direction of the pivot axis.

Such an arrangement of the pivot bearing body has the advantage of a favorable spatial structure of the pivot bearing unit itself and the advantage of a relatively simple sealing of the pivot bearing unit, since the pivot bearing body does not perform any movements in the axial direction of the pivot axis.

Preferably, a seal encircling the pivot axis is provided between a housing of the pivot bearing unit and at least one end face of the outer body and is used to seal against the ingress of dirt and moisture.

In such a solution, the pivot bearing body simultaneously represents the outer body protecting and surrounding the pivot bearing unit, and the fact that the outer body is arranged so that it cannot be displaced relative to the pivot bearing unit in the direction of the pivot axis means in particular that a simple seal can be realized between the outer body and the pivot bearing unit.

A particularly favorable structural solution is one in which the pivot bearing body forms at least one outer body that surrounds a partial region of the rotation blocking device on the outside and is arranged non-displaceably relative to the guide body in the direction of the pivot axis.

In particular, it is provided that the rotation blocking bodies are moveable from the release position to the rotation blocking position by the actuating body.

Preferably, the actuating body is configured in such a way that in the release position it permits the release position of the rotation blocking bodies.

In particular, a further configuration of the rotation blocking body ensures that in the rotation blocking position it holds the rotation blocking bodies in their rotation blocking position.

In order to ensure that the rotation blocking bodies always move into their rotation blocking position, in particular when the actuating body is not actively actuated, it is preferably provided that the actuating body is acted upon by an elastic energy store in the direction of its rotation blocking position.

In order to be able to move the actuating body from the rotation blocking position to the release position, it is preferably provided that the actuating body is moveable from the rotation blocking position to the release position by an actuating unit.

In particular, such a movement of the actuating body by the actuating device takes place against the action of the energy store, i.e., the actuating unit counteracts the action of the energy store and must therefore overcome the forces applied by the energy store.

Particularly in the case of a rotatable actuating body, it is preferable that the actuating unit is used to rotate the actuating body in the opposite direction to the rotational direction caused by the elastic energy store.

In principle, such an elastic energy store can be arranged at several locations.

In terms of structure, it is particularly favorable if the elastic energy store is arranged within the pivot bearing unit.

Another structurally favorable solution is for the elastic energy store to be arranged on one side of the actuating body.

In this case, the elastic energy store can be advantageously coupled with the actuating element.

A wide variety of solutions are conceivable with regard to the action on the actuating body.

For example, one advantageous solution is for the actuating unit to have an output element that is coupled to the actuating body.

In principle, it would be possible to rigidly couple the output element and the actuating body to one another.

However, it is particularly advantageous if the output element and the actuating body are coupled to each other by means of an entrainment coupling device which permits a relative movement through a limited angle of rotation depending on the position of the output element and the position of the actuating body, in particular the rotational position of the latter.

The entrainment coupling device could be an elastic connecting member.

However, it is particularly simple if the entrainment coupling device has an entrainment-free release state and an entrainment state, i.e., either the release state or the entrainment state exists.

In conjunction with the previous solutions, the drive of the rotation blocking device, which makes it possible to realize a transition of the rotation blocking device from at least one rotation blocking position to a release position and vice versa, was explained only in general terms.

Furthermore, it is preferable that the actuating unit for the rotation blocking device comprises a motorized drive unit.

A motorized drive unit associated exclusively with the actuating unit for the rotation blocking device could be provided.

Furthermore, it is preferable that the reduction gearing is arranged on a side of the actuating element of the rotation blocking device facing the motorized drive.

It is particularly advantageous for the compact structure if, viewed in the direction of the pivot axis, the reduction gearing is driven on one side by the motorized drive unit and has an output for the actuating element on the opposite side.

Thus, the reduction gearing is preferably arranged between the motorized drive unit and the actuating element when viewed in the direction of the pivot axis.

Furthermore, the reduction gearing, the elastic energy store and the actuating element are preferably arranged in succession in the direction of the pivot axis, in particular within the pivot bearing unit.

The above description of solutions according to the invention thus comprises, in particular, the various combinations of features defined by the following consecutively numbered embodiments:
1. A trailer coupling, comprising a ball neck (10), which is movable between a working position (A) and a rest position (R) and which is connected at a first end to a pivot bearing unit (20) and carries a coupling ball (18) at a second end, wherein the ball neck (10) is pivotable about a pivot axis (22) between the working position (A) and the rest position (R) by means of the pivot bearing unit (20) in order to execute a pivoting movement, and a rotation blocking device (50) acting between a guide body (40) and a pivot bearing body (14) of the pivot bearing unit (20) and having at least two rotation blocking units (80), each of which has a rotation blocking body (54) which is guided movably in a guide direction (58) by means of a guide receptacle (56) of the guide body (40) and which is movable in the guide direction (58) by a pushing surface (66) extending transversely to the guide direction (58) and provided on an actuating body (52), wherein the rotation blocking bodies (54) of all rotation blocking units (80) are configured to be moved and acted upon in the guide direction (58) by a movement of the actuating body (52) in an actuating direction (72), and wherein the rotation blocking bodies (54) of all rotation blocking units (80) in the working position (A) or the rest position (R) are configured to be brought into a rotation blocking position by movement in the guide direction (58) and in this rotation blocking position each rotation blocking body (54) comes into engagement with one of the at least two working position receptacles (60) or one of the at least two rest position receptacles (60R), in order to block a pivoting movement of the pivot bearing body (14) and of the guide body (40) relative to one another about the pivot axis (22), and wherein the rotation blocking bodies (54) are configured to be brought into a release position and in this position are disengaged from the respective working position receptacle (60) or the respective rest position receptacle (60R) and release the pivoting movement between the pivot bearing body (14) and the guide body (40), wherein in all provided relative pivot positions between the pivot bearing body (14) and the guide body (40), apart from the working position (A) and the rest position (R), a movement of the actuating body (52) in the actuating direction (72) and consequently also a force-loaded engagement of the rotation blocking bodies (54) of each of the rotation blocking units (80) into one of the working position receptacles (60A) or the rest position receptacles (60R) is blocked, characterized in that a blocking device (270) is provided which comprises a blocking body (272) is moveable into a securing position securing the actuating body (52) in the rotation blocking positions and a standby position lying outside the securing position.
2. A trailer coupling in accordance with embodiment 1, wherein the blocking body (272) is guided on the guide body (40) of the pivot bearing unit (20).
3. A trailer coupling in accordance with embodiment 1 or 2, wherein the blocking body (272) is guided in a guide (274) arranged on the guide body (40), in that in particular the guide (274) is arranged in a wall region (104) of the guide body (40) adjacent to the actuating body (52), and in that in particular the wall region (104) is arranged between the actuating body (52) and the pivot bearing body (14).
4. A trailer coupling in accordance with embodiment 3, wherein the blocking body (272) is movable in the guide (274) in a direction approximately parallel to the pivot axis (22).
5. A trailer coupling in accordance with the preceding embodiments, wherein the blocking body (272) in the respective securing position engages in a receptacle (282) in the actuating body (52).
6. A trailer coupling in accordance with the preceding embodiments, wherein the blocking body (272) in the standby position is positioned adjacent to the actuating body (52).
7. A trailer coupling in accordance with the preceding embodiments, wherein the guide (274) for the blocking body (272) is arranged in a wall region (104) of the guide body (40) adjacent to the actuating body (52).
8. A trailer coupling in accordance with embodiments 3 to 7, wherein the blocking body (272) in the securing position, starting from and guided by the guide (274), engages in each case with one end (276) in the respective receptacle (282) of the actuating body (52).
9. A trailer coupling in accordance with the preceding embodiments, wherein the blocking body (272) is fixable in the securing position by an actuating device (280).
10. A trailer coupling in accordance with embodiment 9, wherein the actuating device (280) comprises a camming guide (290) and a cam follower (292) which is moveable by the latter and which is coupled to the blocking body (272).
11. A trailer coupling in accordance with embodiment 10, wherein the cam follower (292) is movable by the camming guide (290) approximately parallel to the pivot axis (22).
12. A trailer coupling in accordance with embodiment 10 or 11, wherein the camming guide (290) is movable in a plane transverse to the pivot axis (22).
13. A trailer coupling in accordance with embodiments 10 to 12, wherein the camming guide (290) is movable by an actuating device (280).
14. A trailer coupling in accordance with embodiment 13, wherein the actuating device (280) comprises a body (142) carrying the camming guide (290) and movable in rotation relative to the cam follower (292).
15. A trailer coupling in accordance with embodiments 10 to 14, wherein the camming guide (290) has at least one camming path (312, 314) acting on the cam follower (292).
16. A trailer coupling in accordance with embodiments 10 to 15, wherein the camming guide(290) has two camming paths (312, 314) acting on the cam follower (292) and guiding it between them.
17. A trailer coupling in accordance with embodiment 16, wherein both camming paths (312, 314) together fix the cam follower (292) in a position predetermining the securing position.
18. A trailer coupling in accordance with embodiments 16 or 17, wherein a first camming path (312) comprises a path portion (312b) moving the cam follower (292) from the position defining the securing position to a position defining the standby position.
19. A trailer coupling in accordance with embodiments 16 to 18, wherein a second camming path (314) comprises a path portion (314b) which moves the cam follower (292) from the position corresponding to the standby position to a position resiliently loading the cam follower (292) towards the securing position.
20. A trailer coupling in accordance with embodiments 16 to 19, wherein the first camming path (312) is effective by a movement of the camming guide (290) in a first rotational direction (322), and in that the second camming path (314) is effective by a movement of the camming guide (290) in a rotational direction (324) opposite to the first rotational direction (322).
21. A trailer coupling in accordance with embodiment 20, wherein the actuating device (280) is drivable by an actuating unit (180) for the rotation blocking device (50).
22. A trailer coupling in accordance with embodiment 21, wherein the actuating device (280) is coupled to the actuating unit (180).
23. A trailer coupling in accordance with embodiment 21 or 22, wherein the camming path (290) is arranged on a rotatable body (142) of a planetary gearing (130) of the actuating unit (180) for the rotation blocking device (50).
24. A trailer coupling in accordance with embodiment 23, wherein the camming path (290) is arranged on a ring gear (142) of a planetary gearing (130) of the actuating unit (180).
25. A trailer coupling in accordance with the preceding embodiments, wherein the blocking device (270) comprises a sensor (300) detecting the positions of the blocking body (272).
26. A trailer coupling in accordance with embodiment 25, wherein the sensor (300) detects the securing position and the standby position.
27. A trailer coupling in accordance with preceding embodiments 9 to 26, wherein the cam follower (292) is coupled to the blocking body (272) by means of a transmission element (294).
28. A trailer coupling in accordance with embodiment 27, wherein the transmission element (294) is coupled to a sensor actuating element (296).
29. A trailer coupling in accordance with the preceding embodiments, wherein blocking surfaces (90) extend between the working position receptacles (60A) and the rest position receptacles (60R), against which blocking surfaces the rotation blocking bodies (54) are placeable and from which the working position receptacles (60A) and the rest position receptacles (60R) extend, in that the rotation blocking units (80) and the working position receptacles (60A) and the rest position receptacles (60R) are arranged around the pivot axis (22) at angular spacings (W) from one another in such a way that, in all provided pivot positions of the pivot bearing body (14) and of the guide body (40) relative to one another, apart from the working position (A) and the rest position (R), the rotation blocking body (54) of at least one of the rotation blocking units (80) is opposite one of the blocking surfaces (90) and thus these blocking surfaces (90), in particular when a force is applied to the actuating body (52) in the direction of the actuating direction (72), block a movement of the actuating body (52) in the actuating direction (72) and consequently also a force-applied engagement of the rotation blocking bodies (54) of each of the rotation blocking units (80) in one of the working position receptacles (60A) or the rest position receptacles (60R).
30. A trailer coupling in accordance with the preceding embodiments, wherein the rotation blocking units (80) are arranged at angular spacings (W) around the pivot axis (22) to form a rotation blocking configuration, in that the working position receptacles (60A) and the rest position receptacles (60R) are arranged at the same angular spacings (W) around the pivot axis (22) as the rotation blocking units (80) in order to form respective receptacle configurations for the working position (A) and the rest position (R), in that the rotation blocking configuration and the receptacle configuration of the working position receptacle (60A) in the working position (A) and of the rest position receptacles (60R) in the rest position (R) are congruent with one another, so that the rotation blocking bodies (54) can engage in the working position receptacles or rest position receptacles, and in that the angular spacings (W) between the rotation blocking units (80) of the rotation blocking configuration and the angular spacings between the working position receptacles (60) or the rest position receptacles (60R) of the receptacle configurations are selected such that the rotation blocking configuration and one of the receptacle configurations are congruent with one another only in the working position (A) or the rest position (R).
31. A trailer coupling in accordance with the preceding embodiments, wherein the angular spacings (W) of at least one of the rotation blocking units (80) are unequal to the rotation blocking units (80) arranged adjacent in a direction of revolution about the pivot axis (22) and to the rotation blocking units (80) arranged opposite to this direction of revolution, in that in the working position (A) the working position receptacles (60A) are arranged in such a way that the rotation blocking body (54) of each of the rotation blocking units (80) is configured to be brought into engagement with one of the working position receptacles (60A), in that in the rest position (R) the rest position receptacles (60R) are arranged in such a way that the rotation blocking body (54) of each of the rotation blocking units (80) is configured to be brought into engagement with one of the rest position receptacles (60R), and in that in all pivot positions of the pivot bearing body (14) and of the guide body (40) relative to one another which are provided for operation and which lie outside the working position (A) or the rest position (R), the rotation blocking body (54) of at least one of the rotation blocking units (80) is located opposite a blocking surface (90) running between the working position receptacles (60A) and the rest position receptacles (60R), and the blocking surface (90) blocks a movement of the actuating body (52) from the release position into the rotation blocking position, in particular when force is applied to the actuating body (52).
32. A trailer coupling in accordance with the preceding embodiments, wherein the blocking surfaces (90) run facing the rotation blocking bodies (54) of the rotation blocking units (80).
33. A trailer coupling in accordance with the preceding embodiments, wherein the blocking surfaces (90) run in a defined radius around the pivot axis (22).
34. A trailer coupling in accordance with the preceding embodiments, wherein the blocking surfaces (90) run as far as the opening edges (92) of the working position receptacles (60A) and the rest position receptacle (60R) and merge into these.
35. A trailer coupling in accordance with embodiment 34, wherein the opening edges (92) of the working position receptacles (60A) and of the rest position receptacle (60R) lie at the same radial spacing from the pivot axis (22) as the blocking surfaces (90).
36. A trailer coupling in accordance with the preceding embodiments, wherein at least one of the rotation blocking bodies (54) of the rotation blocking units (80) abuts in a force-loaded manner against one of the blocking surfaces (90) during a relative pivoting movement between the pivot bearing body (14) and the guide body (40) in the direction of the working position (A), in particular by the action of the actuating body (52).
37. A trailer coupling in accordance with the preceding embodiments, wherein the rotation blocking bodies (54) abut in a force-loaded manner against the blocking surfaces (90) before reaching the working position (A) and then enter the working position receptacles (60A), abutting in a force-loaded manner against opening edges (92) of the working position receptacles (60A).
38. A trailer coupling in accordance with the preceding embodiments, wherein the working position receptacles (60A) extend from the blocking surfaces (90) in the guide direction (58), in particular with at least one component in the radial direction to the pivot axis (22).
39. A trailer coupling in accordance with the preceding embodiments, wherein at least one of the rotation blocking bodies (54) of the rotation blocking units (80) abuts in a force-loaded manner against one of the blocking surfaces (90) during a relative pivoting movement between the pivot bearing body (14) and the guide body (40) in the direction of the rest position (R),
in particular by the action of the actuating body (52).
40. A trailer coupling in accordance with the preceding embodiments, wherein the rotation blocking bodies (54) abut against the blocking surfaces (90) in a force-loaded manner before reaching the rest position (R) and then enter the rest position receptacles (60R), abutting in a force-loaded manner against opening edges (92) of the rest position receptacles (60R).
41. A trailer coupling in accordance with the preceding embodiments, wherein the rest position receptacles (60R) extend from the blocking surfaces (90) in the guide direction (58), in particular with at least one component in the radial direction to the pivot axis (22).
42. A trailer coupling in accordance with the preceding embodiments, wherein the working position receptacles (60A), the rest position receptacles (60R) and the blocking surfaces (90) are arranged facing the guide sleeve (40).
43. A trailer coupling in accordance with the preceding embodiments, wherein the guide body (40) is a part of the pivot bearing unit (20).
44. A trailer coupling in accordance with the preceding embodiments, wherein all guide receptacles (56) for the rotation blocking bodies (54) of the rotation blocking units (80) are arranged in the guide body (40).
45. A trailer coupling in accordance with the preceding embodiments, wherein the guide direction (58) runs with at least one component in the radial direction to the pivot axis (22).
46. A trailer coupling in accordance with the preceding embodiments, wherein the guide body (40) has a guide sleeve (44) with guide receptacles (56) for the rotation blocking bodies (54) of the rotation blocking units (80) and in that in particular the rotation blocking bodies (54) are guided by the guide body (40) adjoining the pivot bearing body (14) in the radial direction.
47. A trailer coupling in accordance with the preceding embodiments, wherein the guide body (40) has a pivot bearing for the pivot bearing body (14).
48. A trailer coupling in accordance with the preceding embodiments, wherein the actuating body (52) is guided movably relative to the guide body (40).
49. A trailer coupling in accordance with the preceding embodiments, wherein the actuating body (52) is arranged rotatably about the pivot axis (22) and in particular has wedge surfaces (66) extending over an angular range about the pivot axis (22) and varying in the direction parallel to the guide direction (58), preferably combined with retraction receptacles (62).
50. A trailer coupling in accordance with the preceding embodiments, wherein the receptacles (60) and the blocking surfaces (90) are arranged on the pivot bearing body (14).
51. A trailer coupling in accordance with the preceding embodiments, wherein the actuating body (52) is surrounded by the guide body (40) and in that in particular the pivot bearing body (14) engages around the guide body (40).
52. A trailer coupling in accordance with the preceding embodiments, wherein the rotation blocking bodies (54) are arranged around the actuating body (52).
53. A trailer coupling in accordance with the preceding embodiments, wherein the pivot bearing body (14) forms an outer body surrounding the guide body (40) on the outside and is arranged non-displaceably relative to the pivot bearing unit (20) in the direction of the pivot axis (22), and in that, in particular, the pivot bearing body (14) forms an outer body surrounding at least a partial region of the rotation blocking unit (50) on the outside and which is arranged non-displaceably relative to the guide body (40) in the direction of the pivot axis (22).
54. A trailer coupling in accordance with the preceding embodiments, wherein the actuating body (52) is acted upon by an elastic energy store (114) in the direction of its rotation blocking position.
55. A trailer coupling in accordance with the preceding embodiments, wherein the actuating body (52) is moveable by an actuating unit (180) from the rotation blocking position into the release position.
56. A trailer coupling in accordance with embodiment 54 or 55, wherein the actuating body (52) is moveable by the actuating unit (180) against the application of force by the energy store (114).
57. A trailer coupling in accordance with embodiments 54 to 56, wherein the actuating body (52) is rotatable by the actuating unit (180) in the opposite direction to the actuating direction (72) caused by the elastic energy store (114).
58. A trailer coupling in accordance with the preceding embodiments, wherein the actuating unit (180) has an output element (142) which is coupled to the actuating body (52).
59. A trailer coupling in accordance with embodiment 58, wherein the output element (142) and the actuating body (52) are coupled to one another by means of an entrainment coupling device (156, 158).
60. A trailer coupling in accordance with embodiment 59, wherein the entrainment coupling device (156, 158) has an entrainment-free release state and an entrainment state.

Further features and advantages of the solution according to the invention are the subject of the following description and the graphical depiction of an exemplary embodiment.

### BRIEF DESCRIPTION OF THE DRAWINGS

FIG. 1 is a rear view of a motor vehicle with a trailer coupling according to the invention;

FIG. 2 is a plan view of a first exemplary embodiment of a trailer coupling according to the invention, looking in the direction of travel towards the trailer coupling mounted on the rear of a vehicle, wherein the trailer coupling is in its working position;

FIG. 3 is a plan view of the trailer coupling in FIG. 2 in the direction of the pivot axis;

FIG. 4 is a view corresponding to FIG. 2 of the trailer coupling in the rest position;

FIG. 5 is a plan view of the trailer coupling according to the trailer coupling according to FIG. 4 in the rest position, in the direction of the pivot axis;

FIG. 6 is a sectional representation along line 6-6 in FIG. 3.

FIG. 7 shows a section along line 7-7 in FIG. 6 in the working position with rotation blocking through rotation blocking bodies in a rotation blocking position;

FIG. 8 is a sectional representation similar to FIG. 7 in the release position with the actuating body rotated into a release position and the rotation blocking bodies in the release position;

FIG. 9 is a representation similar to FIG. 8 with the pivot bearing body slightly pivoted out of the working position, with the blocked actuating body under the action of the torsion spring;

FIG. 10 is a representation similar to FIG. 8 with the pivot bearing body turned further in the direction of the rest position, but in the release position;

FIG. 11 is a representation similar to FIG. 10 with the pivot bearing body turned further in the direction of the rest position;

FIG. 12 is a representation similar to FIG. 11 with the pivot bearing body turned further in the direction of the rest position;

FIG. 13 is a representation similar to FIG. 7 in the rest position;

FIG. 14 is a representation similar to FIG. 8 in the rest position;

FIG. 15 shows a section along line 15-15 in FIG. 6 without support plate and retaining ring;

FIG. 16 is a perspective representation of a ring gear and a drive sleeve interacting therewith;

FIG. 17 is a perspective exploded representation of the pivot bearing body with the cover;

FIG. 18 shows an enlarged section according to FIG. 6 in the working position;

FIG. 19 shows an enlarged section similar to FIG. 18 in the rest position with the blocking body in the release position without locking or securing function;

FIG. 20a-20c are views in the starting position wherein

FIG. 20a is a perspective representation of the interaction of the ring gear in the position according to FIG. 20b with a blocking device and with the rotation blocking device;

FIG. 20b is a plan view of the ring gear of the planetary gearing from the side of the drive sleeve;

FIG. 20c is a perspective representation of the actuation of the sensor;

FIGS. 21a-21c are views in the first position of the ring gear rotated relative to the starting position for releasing the blocking device and without action on the rotation blocking device wherein

FIG. 21a is a perspective representation of the interaction of the ring gear in the position according to FIG. 21b with the blocking device and with the rotation blocking device;

FIG. 21b is a plan view of the ring gear of the planetary gearing from the side of the drive sleeve;

FIG. 21c is a perspective representation of the actuation of the sensor;

FIG. 22a-22c are views in a position of the ring gear rotated relative to the starting position when the release position of the rotational blocking direction is reached wherein

FIG. 22a is a perspective representation of the interaction of the ring gear in the position according to FIG. 22b with a securing device and with the rotation blocking device;

FIG. 22b is a plan view of the ring gear of the planetary gearing from the side of the drive sleeve;

FIG. 22c is a perspective representation of the actuation of the sensor;

FIG. 23a-c are views in a position of the ring gear rotated back in the direction of the starting position compared to the position in FIG. 22a-c when the pivot bearing body reaches the rest position wherein

FIG. 23a is a perspective representation of the interaction of the ring gear in the position according to FIG. 23b with a securing device and with the rotation blocking device;

FIG. 23b is a plan view of the ring gear of the planetary gearing from the side of the drive sleeve;

FIG. 23c is a perspective representation of the actuation of the sensor;

FIGS. 24a-c are views in a position of the ring gear rotated to the starting position wherein

FIG. 24a is a perspective representation of the interaction of the ring gear in the position according to FIG. 24b with a securing device and with the rotation blocking device;

FIG. 24b is a plan view of the ring gear of the planetary gearing from the side of the drive sleeve;

FIG. 24c is a perspective representation of the actuation of the sensor;

FIGS. 25a-c are views in a position of the ring gear rotated to the starting position according to FIG. 20a-c when the rotation blocking device moves to the rotation blocking position and the blocking device moves to the securing position wherein

FIG. 25a is a perspective representation of the interaction of the ring gear in the position according to FIG. 25b with a securing device and with the rotation blocking device;

FIG. 25b is a plan view of the ring gear of the planetary gearing from the side of the drive sleeve;

FIG. 25c is a perspective representation of the actuation of the sensor.

### DETAILED DESCRIPTION OF THE INVENTION

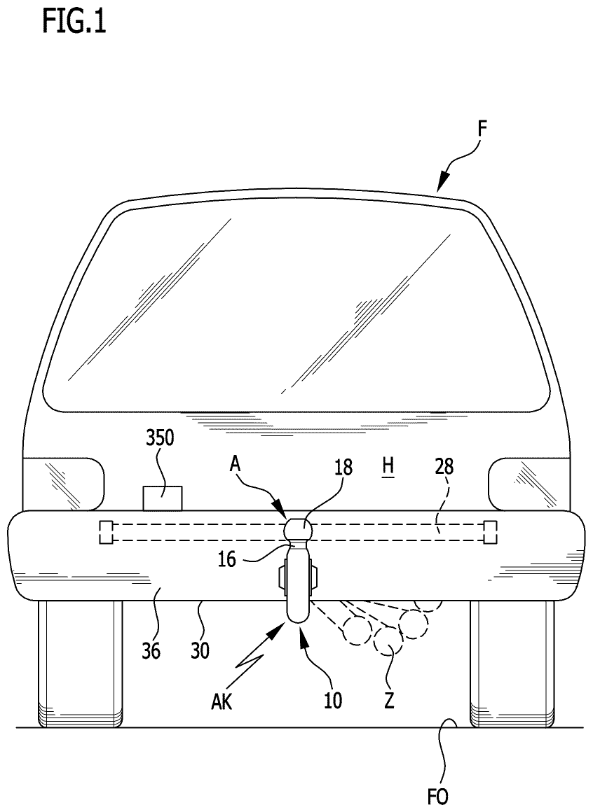

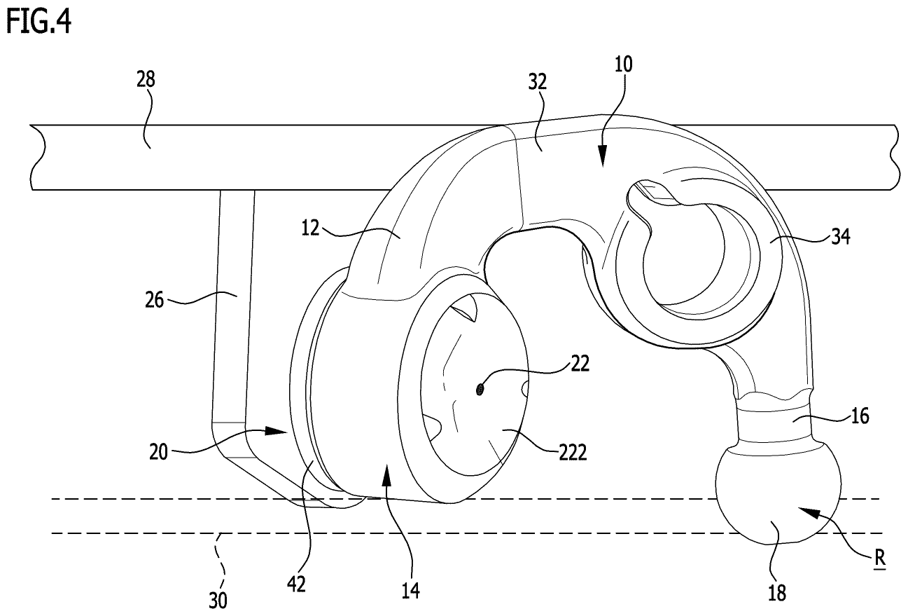

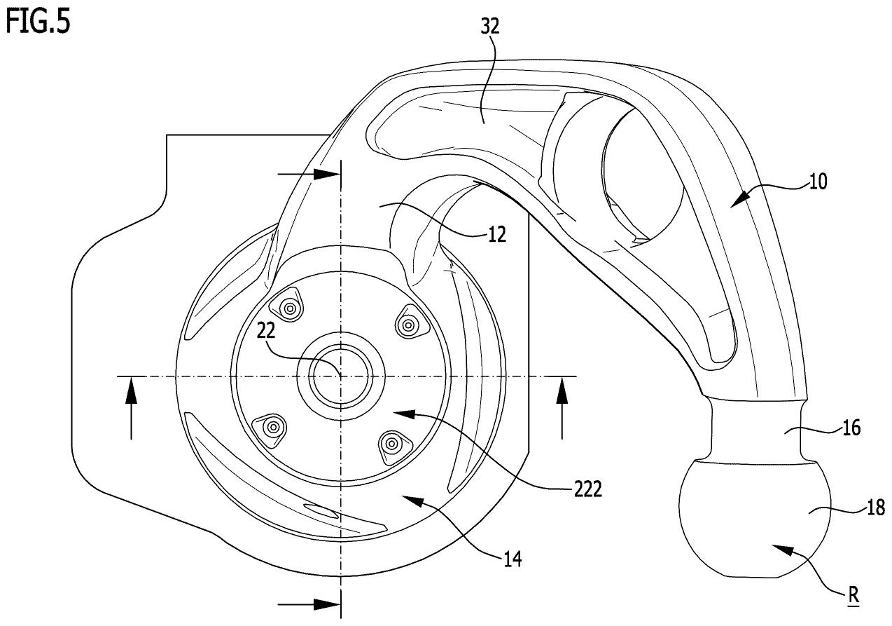

A first exemplary embodiment of a trailer coupling AK for a motor vehicle according to the invention, shown in FIGS. 1, 2 and 3 in an operating position A and in FIGS. 4 and 5 in a rest position R, comprises a ball neck designated as a whole by 10, which is held at a first end 12 on a pivot bearing unit 20 and at a second end 16 carries a coupling ball designated as a whole by 18, on which a coupling ball receptacle of a trailer can be fixed.

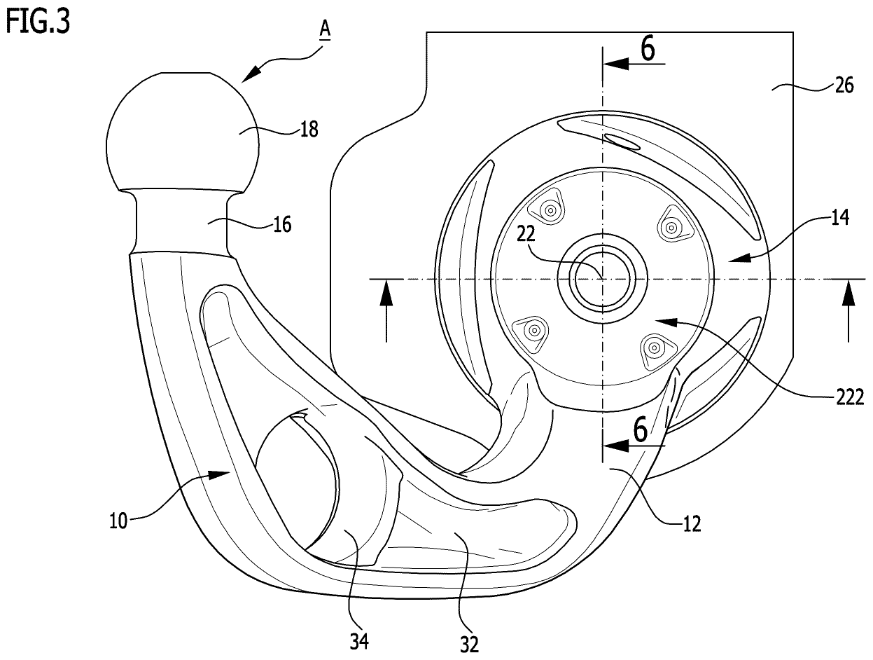

The ball neck 10 is mounted pivotably about a pivot axis 22 relative to a carrier 24, fixed to the vehicle, by a pivot bearing unit designated as a whole by 20, wherein the carrier 24 preferably has a support plate 26 holding the pivot bearing unit 20, which preferably extends in a plane perpendicular to the pivot axis 22, and has a cross member 28, fixed to the vehicle, which can be fastened in a known manner to a rear region H of a vehicle body F, more specifically in such a way that the pivot bearing unit 20 and the carrier 24 lie on a side of a lower edge 30 of a bumper unit 36 facing away from a road surface FO and are covered by the bumper unit 36 (FIG. 3).

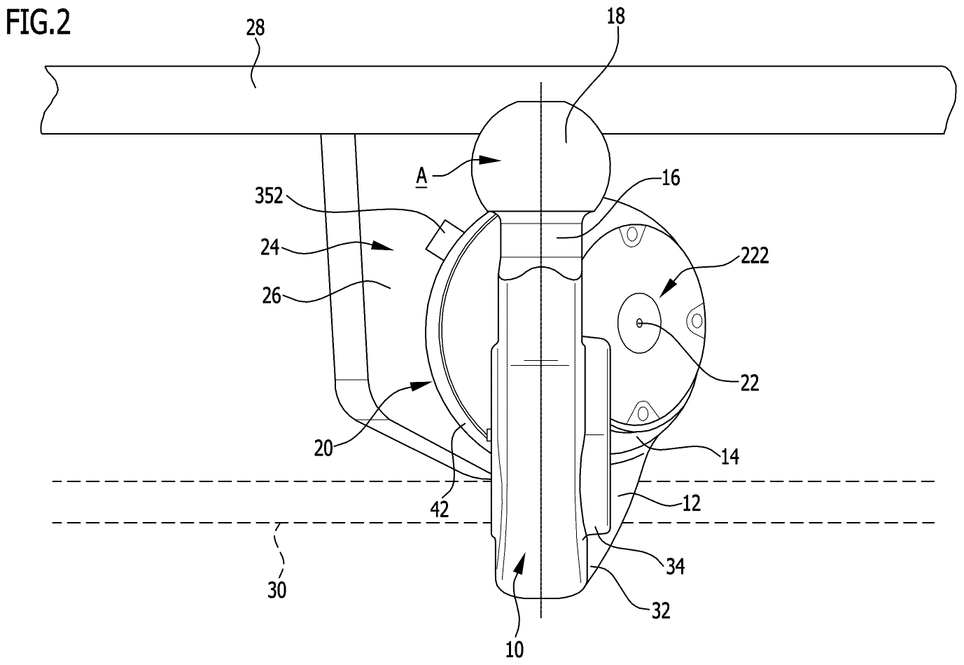

In the working position shown in FIGS. 1 and 2, the ball neck 10 engages below the lower edge 30 of the bumper unit 36 with a portion 32 adjoining the first end 12, so that the second end 16 and the coupling ball 18 together with a socket receptacle 34 are located on a side of the rear bumper unit 36 facing away from the vehicle body F, while in the rest position, both the pivot bearing unit 20 and the entire ball neck 10 together with the coupling ball 18 are covered by the rear bumper unit 36 so that they cannot be seen from behind.

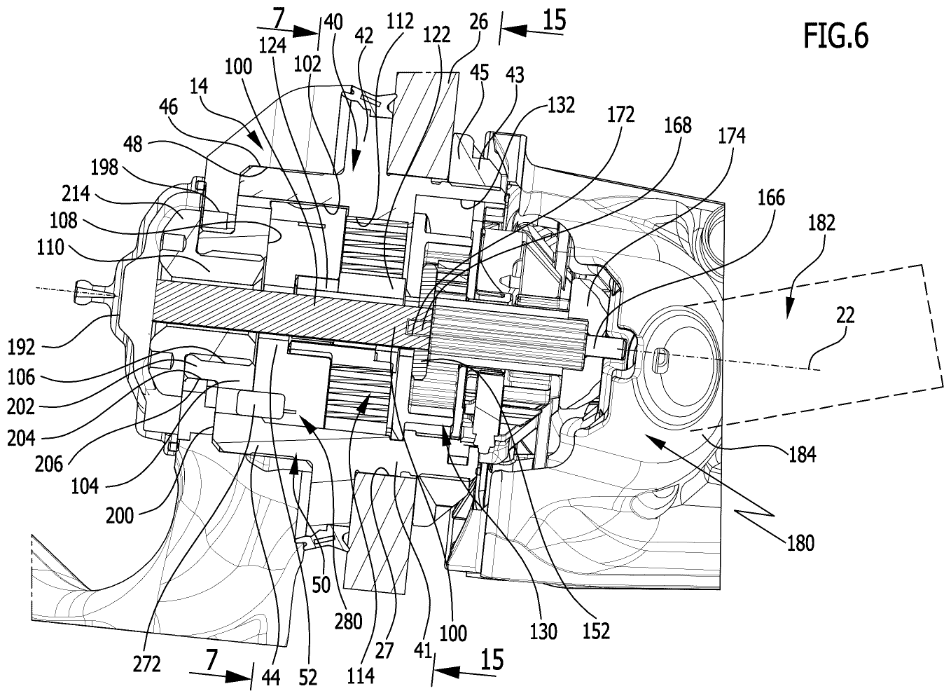

As shown in FIGS. 6 to 9, the pivot bearing unit 20 comprises a pivot bearing body 14 on the one hand and a guide body 40 on the other.

For example, the guide body 40 is firmly connected to the support plate 26 by a flange 42 and a guide sleeve 44 extending from the flange 42 away from the support plate 26, on which the pivot bearing body 14 is rotatably mounted about the pivot axis 20, wherein the ball neck 10 is held on this.

Alternatively, however, it is also conceivable to connect the pivot bearing body 14 firmly to the flange 42 and to arrange the ball neck 10 on the guide body 40.

The guide sleeve 44 comprises a cylindrical outer surface 46, against which the pivot bearing body 14 bears with a cylindrical inner surface 48 in order to obtain a rotation guide about the pivot axis 22, so that the pivot bearing body 14 and the guide body 40 and are rotatable relative to one another and thus the ball neck 10 is pivotable from the working position A into the rest position R and vice versa.

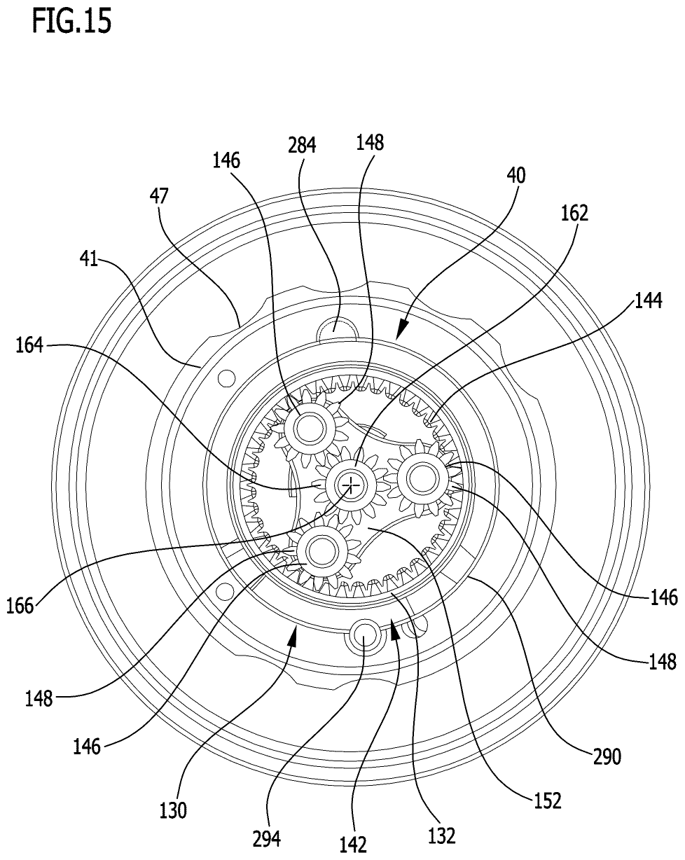

In the case of its fixed mounting, the guide body 40 comprises an extension 41 extending through an aperture 27 in the support plate 26, which extension carries a receptacle 43, following the extension 41 on a side opposite the flange 42, for a retaining ring 45 fixable to the extension, so that the guide body 40 is seated by the extension 41, due to its non-rotationally symmetrical but radially varying outer contour 47 (FIG. 15), in the correspondingly shaped aperture 27 in a rotationally fixed manner in the support plate 26 and is fixed to the latter by the flange 45 and the retaining ring 43, which abut on opposite sides of the support plate 26.

The guide body 40 thus forms the pivot bearing, fixed to the vehicle, for the pivot bearing body 14 due to its fixed connection with the support plate 26 and the carrier 24.

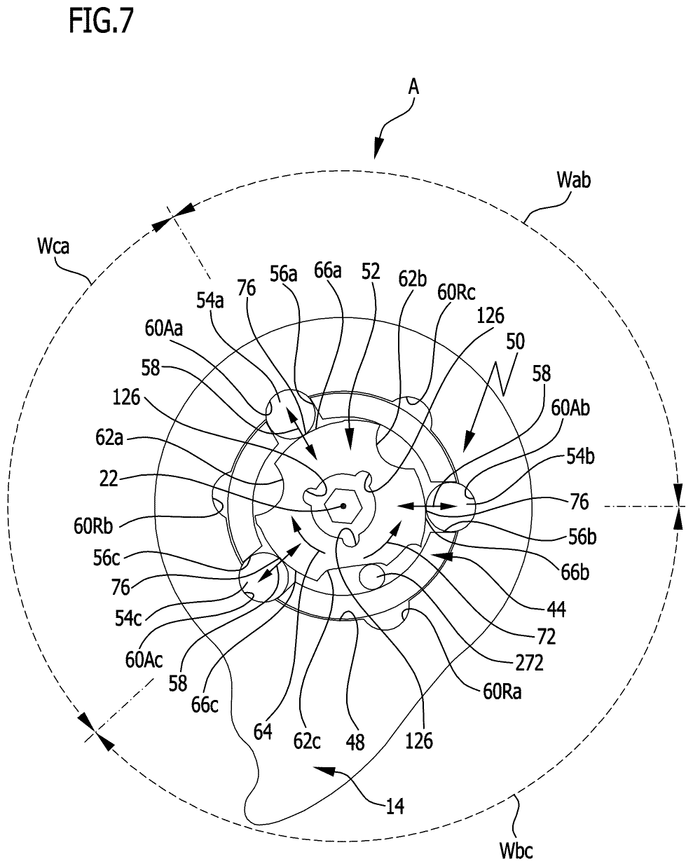

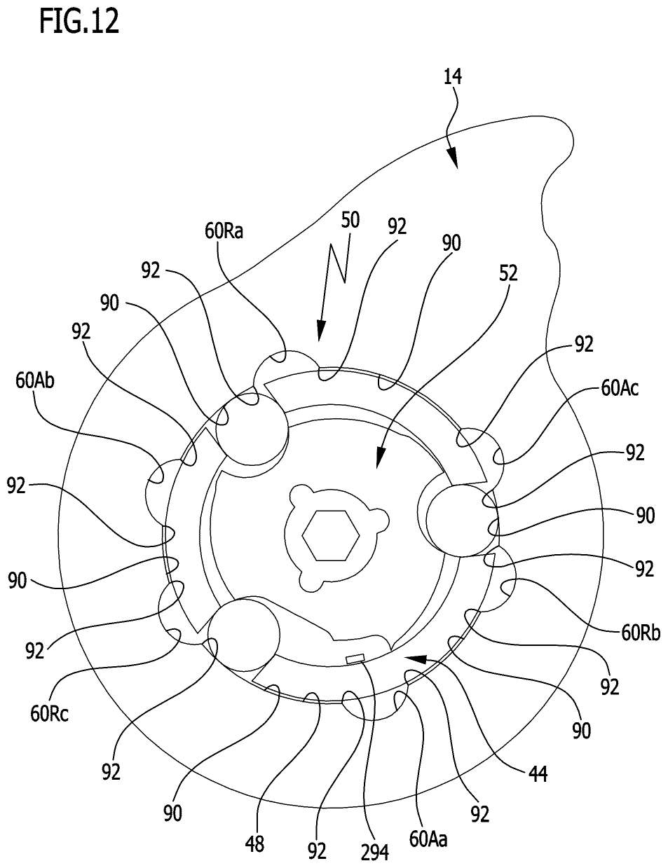

In order to fix the pivot bearing body 14 in the working position A, the pivot bearing unit 20 is provided with a rotation blocking device (FIGS. 7 to 14) designated as a whole by 50, which comprises an actuating body 52 and a plurality of rotation blocking bodies 54, which are acted upon by the actuating body 52 and each of which is guided in a guide receptacle 56 of the guide sleeve 44 so as to be movable in a guide direction 58 extending substantially radially to the pivot axis 22.

Preferably, at least the rotation blocking bodies 54 and the guide receptacles 56 are arranged symmetrically with respect to a geometric plane extending perpendicularly to the pivot axis 22 and intersecting the rotation blocking bodies 54, which geometric plane corresponds to the drawing plane in FIGS. 7 to 14.

Furthermore, starting from the inner surface 48 of the pivot bearing body 14, the rotation blocking device 50 comprises working position receptacles 60A, which extend into the pivot bearing body, in particular in the radial direction relative to the pivot axis 22 and with which the rotation blocking bodies 54 can be brought into engagement in the working position A, wherein the working position receptacles 60A have wall surfaces which are increasingly spaced apart from one another by a smaller spacing in the radial direction relative to the pivot axis 22.

Furthermore, in addition to the working position receptacles 60A, the rotation blocking device 50 comprises rest position receptacles 60R, which in the simplest case are configured in the same way as the working position receptacles 60A.

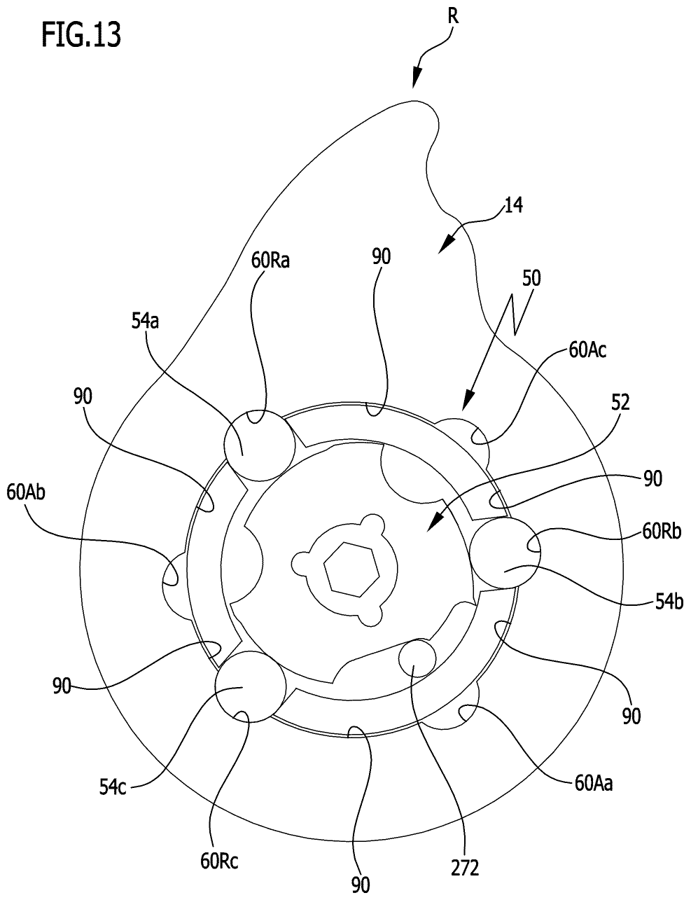

If, for example, the rotation blocking device 50, as shown in conjunction with FIG. 7 to FIG. 14 in the first exemplary embodiment, comprises a set of three rotation blocking bodies 54a, 54b and 54c, the guide sleeve 44 has a corresponding set of three guide receptacles 56a, 56b and 56c, in which the rotation blocking bodies 54a, 54b and 54c are displaceably guided in the guide direction 58 extending substantially radially to the pivot axis 22, and the pivot bearing body 14 is provided with a set of working position receptacles 60Aa, 60Ab and 60Ac, with which the rotation blocking bodies 54a, 54b and 54c are configured to be brought into engagement in the working position A (FIG. 7), and provided with a set of rest position receptacles 60Ra, 60Rb, 60Rc, with which the rotation blocking bodies 52 are configured to be brought into engagement in the rest position R (FIG. 13).

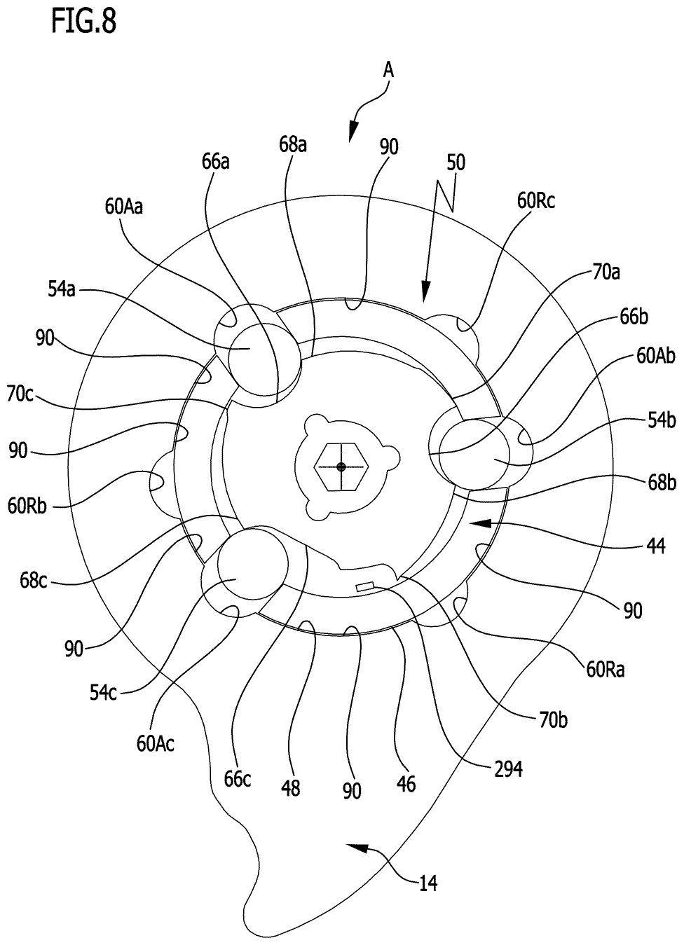

For suitable movement and positioning of the rotation blocking bodies 54 in the guide direction 58, the actuating body 52 is provided with a set of, for example, a total of three, retraction receptacles 62a, 62b and 62c corresponding to the number of rotation blocking bodies 54 and pushing surfaces 66a, 66b and 66c adjoining the respective retraction receptacles 62a, 62b, 62c in a direction of revolution 64, which pushing surfaces are configured as wedge surfaces acting radially to the pivot axis 22, wherein the rotation blocking bodies 54 in their release position can enter into the retraction receptacles 62a, 62b, 62c to such an extent (FIG. 8) so that they no longer protrude beyond the outer surface 46 of the guide sleeve 44, and wherein the pushing surfaces 66a, 66b, 66c each extend increasingly radially outwardly relative to the pivot axis 22 from a radially inner starting region 68a, 68b and 68c adjoining the respective retraction receptacles 62, with increasing extension in the direction of revolution 64, up to a radially outer end region 70a, 70b and 70c and thus act as wedge surfaces on the rotation blocking bodies 54 during a rotation movement of the actuating body 52 in order to move these rotation blocking bodies into their rotation blocking position.

Preferably, the pushing surfaces 66 extend as spiral or involute segments relative to the pivot axis 22.

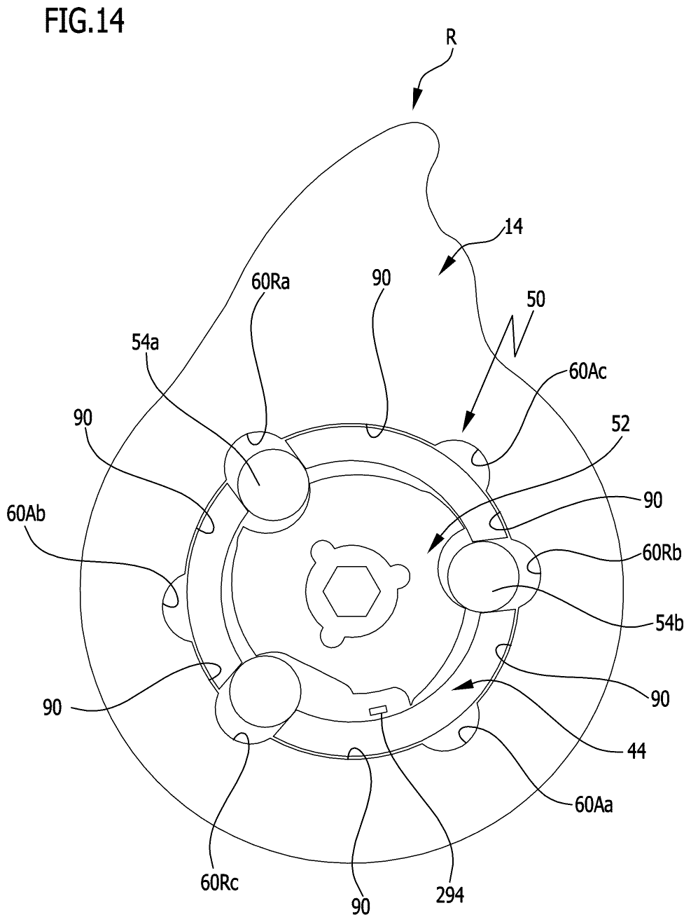

In order to either hold the rotation blocking bodies 54 in their rotation blocking position by acting on them with the pushing surfaces 66 between the starting region 68 and the end region 70 or to allow them to enter into the retraction receptacles 62 in the release position, the actuating body 52 is also rotatable about the pivot axis 22, in particular coaxially thereto, and in such a way that either the set of retraction receptacles 62a, 62b and 62c faces the rotation blocking bodies 54 and, as shown in FIG. 8, in their inactive position or release position, enables them to enter into the retraction receptacles 62 in a radial direction towards the pivot axis 22 during the transition to the release position, in order to enable the respective rotation blocking bodies 54 to leave the working position receptacles 60A or the rest position receptacles 60R and to release the pivot bearing body 14 with respect to a rotation about the pivot axis 22 relative to the guide body 40, so that the pivot bearing body 14 with the ball neck 10 is unhindered and freely rotatable relative to the guide sleeve 44, as shown in FIG. 8 and FIG. 14, wherein in this case the rotation blocking bodies 54 do not extend beyond the outer surface 46 of the guide sleeve 44.

A rotation of the actuating body 52 in a rotational direction 72 opposite to the direction of revolution 64 with the rotation blocking bodies 54 seated in the retraction receptacles 62 has the effect that the rotation blocking bodies 54 are moved out of the retraction receptacles 62 and initially rest on the starting regions 68 of the pushing surfaces 66 in the active position or rotation blocking position of the actuating body 52, but in the process already enter into the receptacles 60, for example, and thus prevent the pivot bearing body 14 from rotating freely relative to the guide body 40 in its rotation blocking position.

If the actuating body 52 is rotated further in the rotational direction 72 in the opposite direction to the direction of revolution 64, the regions of the pushing surfaces 66 that are located increasingly radially outwardly relative to the pivot axis 22 act on the rotation blocking bodies 54 and thus increasingly press the rotation blocking bodies 54 in the working position A or the rest position R of the ball neck 10 into the working position receptacles 60Aa, 60Ab and 60Ac, FIG. 7, or into the rest position receptacles 60Ra, 60Rb and 60Rc, FIG. 13, in order to thus achieve a substantially play-free fixing of the pivot bearing body 14 relative to the guide body 40, in this case to the guide sleeve 44.

In the rotation blocking position of the rotation blocking bodies 54, the actuating body 52 is in its active position such that the rotation blocking bodies 54, as shown in FIG. 7 and FIG. 13, sit approximately on central regions 76, which lie between the starting regions 68 and the end regions 70, of the pushing surfaces 66 and are acted upon by these.

In order to enable the actuating body 52 to act optimally on each of the three rotation blocking bodies 54, it is provided that, in the active position, the actuating body 52 is centered according to the position of the rotation blocking bodies 54. In particular, the actuating body 52 is mounted in the guide sleeve 44 in such a way that the actuating body 52 can center itself within the guide body 40 due to the radial play relative to the position of the rotation blocking bodies 54 caused by manufacturing tolerances, wherein the self-centering of the actuating body 52 can deviate slightly from a coaxial arrangement relative to the geometric pivot axis 22.

Due to the self-centering, the rotation blocking bodies 54a, 54b and 54c act in the respective guide direction 58a, 58b and 58c with approximately equally large forces on the working position receptacles 60Aa, 60Ab and 60Ac or the rest position receptacles 60Ra, 60Rb and 60Rc, so that the reaction forces acting on the actuating body 52 are also approximately equally large.

Preferably, the rotation blocking bodies 54 are configured as balls, which thus abut against the actuating body 52 on the one hand and also against the receptacles 60 on the other.

Thus, there is only a rotatable bearing with play of the actuating body 52 relative to the pivot axis 22, which is primarily relevant when the actuating body 52 holds the rotation blocking bodies 54 in a release position in which the rotation blocking bodies 54 enter into the retraction receptacles 62 of the actuating body 52.

In order to cause the actuating body 52 to always move in the rotational direction 72 without external influence in such a way that the rotation blocking bodies 54 move in the direction of the rotation blocking position, the actuating body 52 is acted upon by a torsion spring 114 (FIG. 6), which on the one hand acts on the actuating body 52 and on the other hand is supported radially externally on the guide body 40.

The torsion spring 114 also causes the actuating body 52 to press the rotation blocking bodies 54 into the working position receptacles 60A or the rest position receptacles 60R in a force-loaded manner, and thus the pivot bearing body 14 is fixed without play, the freedom from play being maintained even if the geometry of the working position receptacles 60A or the rest position receptacles 60R changes due to the loads during operation by further rotation of the actuating body 52 in the rotational direction 72.

The, for example, three guide receptacles 56 and the rotation blocking bodies 54 arranged in these, as well as the retraction receptacles 62 respectively associated with these rotation blocking bodies 54 with the pushing surfaces 66 adjoining these in the actuating body 52 each form three rotation blocking units 80 and these are arranged around the pivot axis 22 at unequal angular spacings Wab, Wbc, Wca (in relation to the respective center axes Ma, Mb, Mc) relative to one another, whereby, in relation to the pivot axis 22 as the axis of rotation, a rotation blocking configuration of the rotation blocking units 80 only leads to a congruent arrangement of the rotation blocking units 80 when the rotation blocking configuration is rotated through 360°.

For example, the angular spacing Wab=120°, the angular spacing Wbc=137° and the angular spacing Wca=103°, which means that the deviation from equal angular spacings is 17°.

With three rotation blocking units, for example, deviations from equal angular spacings of up to 30° or more are also possible, so that angular spacings of Wab=120°, Wbc=150° and Wca=90° are possible, for example.

Similarly, the working position receptacles 60A and the rest position receptacles 60R are each arranged relative to one another in relation to the pivot axis 22 in a receptacle configuration with the same angular spacing as the rotation blocking units 80 relative to one another, which also lead to a congruent arrangement of the respective receptacle configuration in relation to the pivot axis 22 only when rotating through 360°, so that in the working position A or the rest position R, this is congruent with the rotation blocking configuration, so that in the working position A or the rest position R, in each case a rotation blocking body 54 of one of the rotation blocking units 80 is opposite one of the working position receptacles 60A or one of the rest position receptacles 60R and can engage with the latter in the rotation blocking position, as shown in FIG. 7 and FIG. 13, as a result of which the pivot bearing body 14 can only be fixed in a rotationally fixed manner relative to the pivot bearing unit 20 in the working position and in the rest position (FIG. 7, FIG. 13).

However, if the actuating body 52 is moved into the release position in the working position A or the rest position R against the force effect of the torsion spring 114, as described below, each of the rotation blocking bodies 54 of the respective rotation blocking unit 80 has the possibility of entering into the retraction receptacle 62 associated therewith and of leaving the respective working position receptacle 60A or rest position receptacle R, so that the pivot bearing body 14 is pivotable out about the pivot axis 22 in the working position A or the rest position R (FIG. 8, FIG. 14).

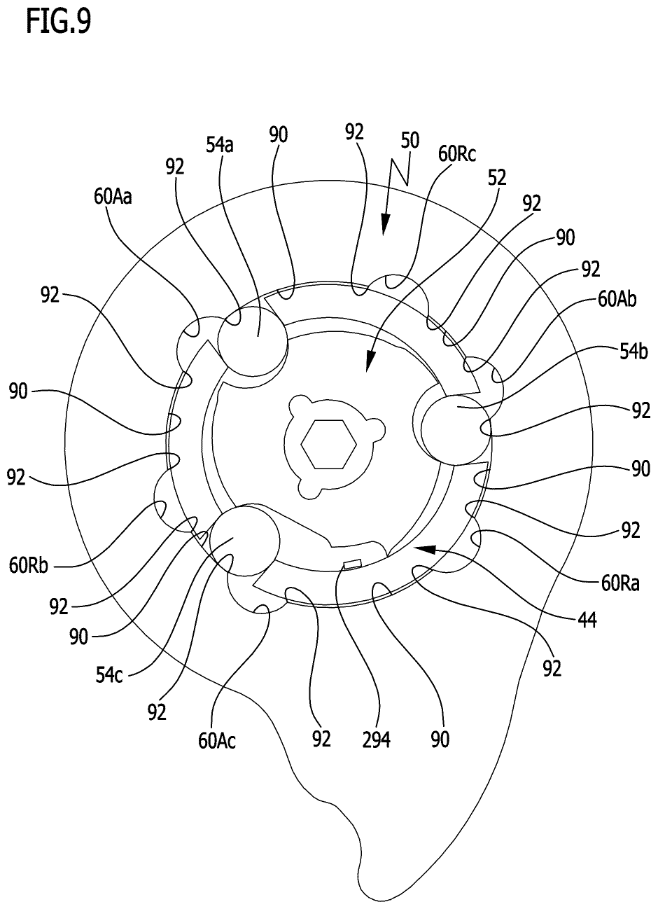

As soon as the pivot bearing body 14 has left the working position A or the rest position R (FIG. 9), the entirety of the rotation blocking units 80 arranged relative to the pivot axis 22 in the rotation blocking configuration no longer has the possibility of engaging with the entirety of the working position receptacles 60A or rest position receptacles 60R arranged in the respective receptacle configuration in all pivot positions between the working position A or the rest position R, so that when the actuating body 54 is acted upon in the rotational direction 72, the entirety of the rotation blocking bodies 54 seated in the retraction receptacles 62 can no longer engage in the entirety of the working position receptacles 60A or the rest position receptacles 60R, since the rotation blocking bodies 54 can indeed be acted upon in the rotational direction of the pivot bearing body 14 by the actuating body 52 acted upon by the torsion spring 114 in the rotational direction 72, in particular by the curved base surfaces of the retraction receptacles 62 extending at an angle to the guide direction 58, however, in each of the rotational positions of the pivot bearing body 14 lying outside the working position A, there is never arranged opposite the totality of the rotation blocking bodies 54 a respective receptacle from the totality of the working position receptacles 60A or the rest position receptacles 60R, and thus at least one of the rotation blocking bodies 54 is always blocked by one of the blocking surfaces 90 running between the working position receptacles 60A and rest position receptacles 60R and formed in the simplest case by the cylindrical inner surface 48 of the pivot bearing body 14, and thereby prevents rotation of the actuating body 52 in the rotational direction 72 caused by the torsion spring 114, so that the actuating body 52 is thereby held in the release position in all pivot positions of the pivot bearing body 14 outside the working position A and the rest position R, even when the torsion spring 114 acts in the rotational direction 72, and can consequently only move back into the rotation blocking position when the working position A is reached.

Preferably, the deviation of the rotation blocking configuration of the rotation blocking unit 80 and the receiving configuration of the receptacles 60 from a symmetrical configuration is such that when one of the rotation blocking units 80 is opposite one of the working position receptacles 60A or the rest position receptacles 60R, so that the rotation blocking body 54 could engage with this working position receptacle 60A or the rest position receptacles 60R, at least one, even better at least two, of the rotation blocking units 80 are offset in the rotational direction relative to the nearest receptacle of the working position receptacle 60A or of the rest position receptacles 60R to such an extent that a point of contact of the rotation blocking body 54 associated with this rotation blocking unit 80 is already located on one of the blocking surfaces 90 and cannot come to rest in the region of one of the receptacles 60, so that reliable blocking of the actuating body 52, in particular when the actuating body 52 is acted upon by the torsion spring 114 in the rotational direction 72, is ensured by the blocking surfaces 90 which are effective in the release position.

If the actuating body 52 is acted upon with a rotational direction 64 opposite to the action of the torsion spring 114 and is rotated to the maximum, the rotation blocking bodies 54 lie with play between the respective blocking surface 90 and the retraction receptacles 62 in all pivot positions of the pivot bearing body 14.

If, however, the effect of the torsion spring 114 dominates in the rotational direction 72, then conditions as shown in FIGS. 9 to 12 also exist in the respective pivot positions of the pivot bearing body 14 when pivoting between the working position A and the rest position R.

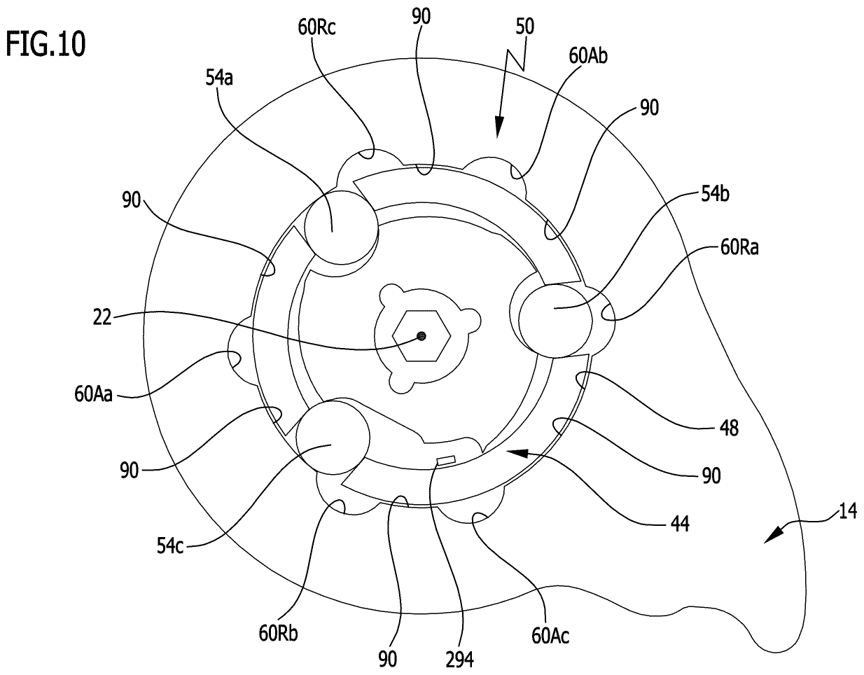

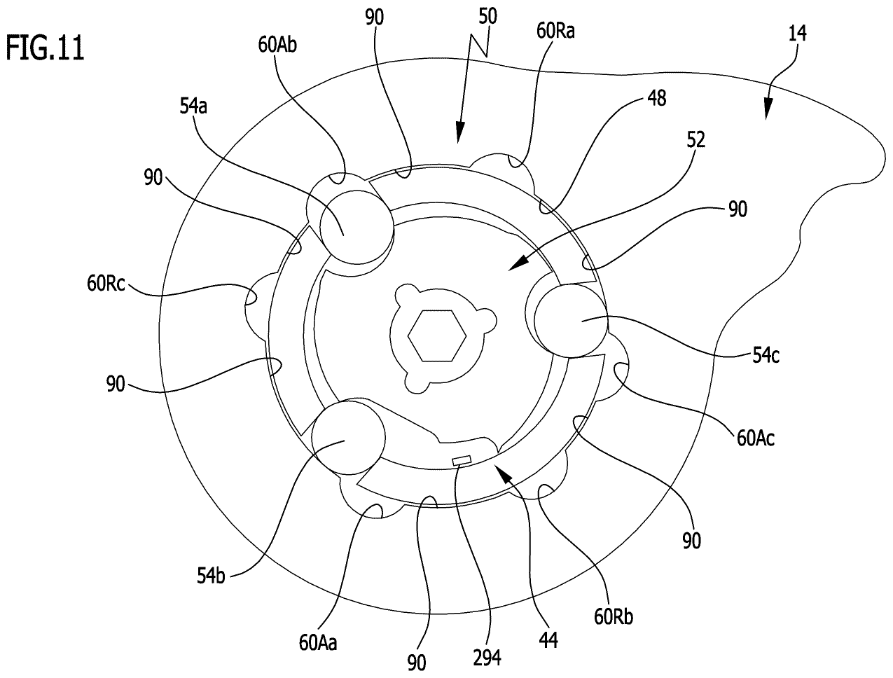

FIGS. 9 to 12 show that the actuating body 52 is held in the release position in each of the pivot positions of the pivot bearing body 14 by at least one, preferably two, rotation blocking bodies 54, which abut against one of the blocking surfaces 90, and prevent one of the rotation blocking bodies 54, for example the rotation blocking body 54b in FIG. 10 or the rotation blocking body 54a in FIG. 11, from engaging in the respective receptacle 60 aligned therewith.

In any case, the conditions according to FIGS. 7 to 14 exist when pivoting between the rest position R and the working position A, wherein, due to the abutting of the rotation blocking bodies 54 against the blocking surfaces 90 according to FIGS. 9 to 12 during pivoting between the rest position R and the working position A, the rotation blocking bodies 54 slide with low noise generation from the blocking surfaces 90 by means of opening edges 92 of the working position receptacles 60A and the rest position receptacles 60R, which are directly and in particular steplessly adjacent thereto, into the working position receptacles 60A or the rest position receptacles 60R and pass into the rotation blocking position according to FIG. 7 or FIG. 13.

The guide sleeve 44 preferably extends with a portion forming a receptacle 102 for the actuating body 52 between the flange 42 and a flange 104 terminating the guide sleeve 44 and extending radially towards the pivot axis 22, which flange is preferably formed in one piece on the guide sleeve 44 and delimits the receptacle 102 for the actuating body 52, so that the actuating body 52 is guided radially relative to the pivot axis 22 through the receptacle 102 of the guide sleeve 44 and is guided axially in the direction of the pivot axis 22 by abutting against an inner side 108 of the flange 104.

The flange 104 also has a receptacle 106 coaxial with the pivot axis 22, into which receptacle an insert 110 is inserted, in particular screwed in, which insert is penetrated by a stationary shaft 100 and which is seated in the receptacle 106 and fixes the shaft 100 non-rotatably relative to the guide sleeve 44.

On a side of the receptacle 102 for the actuating body 52 opposite the flange 104, the guide sleeve 44 forms, for example with a portion passing through the flange 42, a torsion spring receptacle 112, in which the torsion spring 114 is arranged in connection with the actuating body 52, which torsion spring on the one hand is fixed with an outer end in the torsion spring receptacle 112 and is connected with an inner end to a drive sleeve 122, which is coupled non-rotatably to the actuating body 52.

For this purpose, the drive sleeve 122, as shown in FIGS. 6, 7 and 16, is provided, for example, with extensions 124 which engage in corresponding recesses 126 in the actuating body 52 to produce a positively-locking connection.

Due to the fact that the torsion spring 114 acts on the drive sleeve 122, which is coupled to the actuating body 52 for conjoint rotation, the actuating body 52 is driven in the rotational direction 72 by the action of the torsion spring 114 on the drive sleeve 122, so that the actuating body 52 always acts on the actuating body 52 in the rotational direction 72 when the torsion spring 114 acts unhindered on the drive sleeve 122, so that the actuating body has the tendency to move the rotation blocking bodies 54 radially outwards away from the pivot axis 22 in a force-loaded manner in the guide direction 58, wherein this movement is prevented by the blocking surfaces 90 in all provided pivot positions of the pivot bearing body 14, apart from the working position A and the rest position R, and consequently the rotation blocking bodies 54 are pressed into the working position receptacles A and the rest position receptacles R only in the working position A and the rest position R, thereby fixing the pivot bearing body 14 relative to the guide sleeve 44 in a rotationally fixed and, in particular, play-free manner.

In order to be able to move the rotation blocking bodies 54 into the release position, an action on the actuating body 52 is required in the opposite direction to the rotational direction 72 and thus also in the opposite direction to the action of the torsion spring 114.

For this purpose, the drive sleeve 122 is drivable by means of a planetary gearing 130 designated as a whole by 130 (FIG. 6), which is arranged in a gearing receptacle 132 of the guide sleeve 44, in particular coaxially to the pivot axis 22, which is arranged, for example, partially within the aperture 27 of the carrier plate 26 and preferably extends away from the aperture 27 of the carrier plate 26 on a side opposite the flange 42.

For its part, the planetary gearing 130 (FIG. 15) comprises a ring gear 142, which is guided in the gearing receptacle 132 and is provided with an internal toothing 144, with which planet gears 146 are engaged with their external toothing 148.

The planet gears 146 are rotatably held on a planet gear carrier 152, which in turn is connected non-rotatably to the stationary shaft 100.

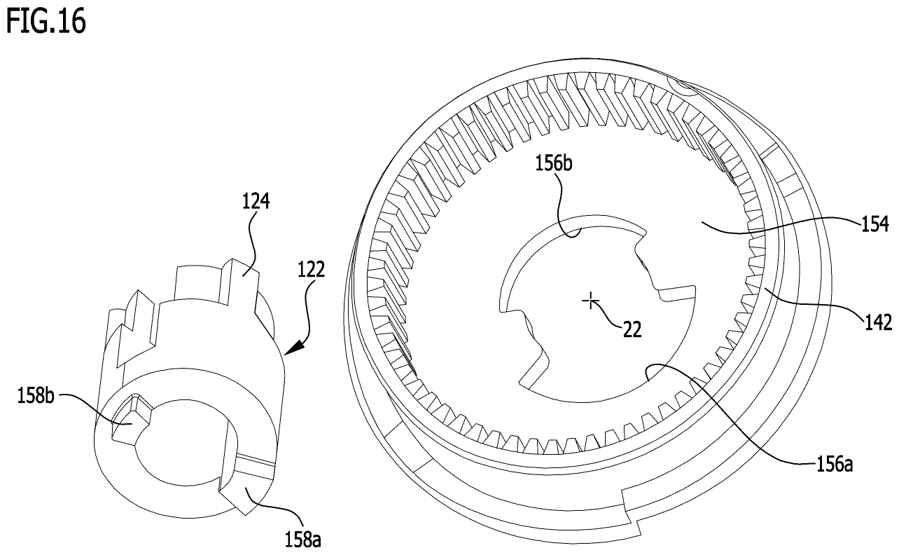

Furthermore, as shown in FIG. 16, the ring gear 142 comprises a flange body 154, which is located between the planet gear carrier 152 and the torsion spring 114 and which also extends in the direction of the shaft 100, surrounds it, but is rotatable relative to it and forms an output of the planetary gear 130 for actuating the rotation blocking device 50.

As shown in FIG. 16, the flange body 154 has circular arc-shaped drive slots 156a, 156b arranged circumferentially around the pivot axis 22, which interact with drive fingers 158a, 158b of the drive sleeve 122 engaging therein, and which are, however, formed in such a way, that the difference between the angular range around the pivot axis 22, over which the drive slots 156 extend, and the angular range around the pivot axis 22, over which the drive fingers 158 extend, enables the drive sleeve 122 to move freely relative to the ring gear 142, which will be explained in detail below.

Furthermore, the planet gears 146 are in engagement with their external toothing 148 with an external toothing 164 of a sun gear 162 of the planetary gearing 130, which is seated on a drive shaft designated as a whole as 166, which is arranged coaxially to the pivot axis 22 and is mounted coaxially to the stationary shaft 100, for example by means of an end shaft stub 168, which engages in an end-face bore 172 of the stationary shaft.

At a spacing from the planetary gearing 130, the drive shaft 166 carries a drive gear 174, for example a bevel gear, which is driven by an output gear of a motorized drive unit 182, which comprises, for example, on the one hand a drive motor, preferably an electric motor, and on the other hand a reduction gearing for driving the drive gear.

The drive unit 182 is held, for example, on a cover body 184 which, starting from the carrier plate 126, engages over the drive shaft 166 with the drive gear 174 and over the output gear meshing therewith and also supports the drive shaft 166 on a side facing away from the shaft stub 168.

Thus, the planetary gearing 130 and the drive unit 182 form, for example, an actuating device 180 for the rotation blocking device 50.

The stationary shaft 100, which is non-rotatably coupled to the planet gear carrier 152, is non-rotatably connected to the flange 104 of the guide body 40.

An end flange 198 of the pivot bearing body 14 engages over the flange 104 of the guide body 40 in the outer region 200 and extends up to a guide projection 202 of the flange 104, wherein the end flange 198 engages, for example, with a radially inner cylindrical surface 204 around an outer cylindrical surface 206 of the guide projection 202 and, for example, abuts against the latter and is thereby also additionally guided on the guide projection 202 coaxially to the pivot axis 22.

In addition, there extends in the receptacle 106 of the guide projection 202 a thread 212, in which the insert 110 is fixed, in particular screwed in, which partially engages with an outer flange 214 over the end flange 198 in a radially inner region, so that the end flange 198 of the pivot bearing body 14 is guided axially non-displaceably between the flange 104 and the outer flange 214 of the insert 110 and thus axially non-displaceably relative to the guide body 40.

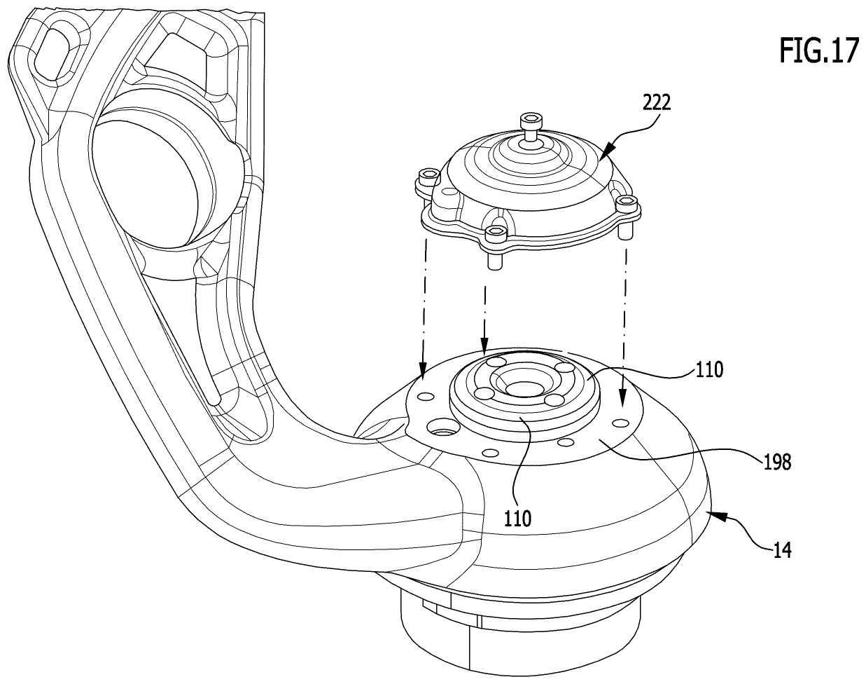

Furthermore, a cover 222 is non-rotatably mounted on the end flange 198, so that the cover 222 forms a unit with the pivot bearing body 14, which is rotatable about the pivot axis 22 (FIG. 17).

The cover 222 sits on the end flange 198 and is fixed to it non-rotatably.

In the solution described above, a set of working position receptacles 60A is provided for the non-rotatable fixing of the pivot bearing body 14 in the working position A, and a set of rest position receptacles 60R is provided for the non-rotatable fixing of the pivot bearing body 14 in the rest position R.

For safe operation of the trailer coupling according to the invention, a blocking device designated as a whole by 270 is provided, which comprises a blocking body 272, which in turn is guided in a guide 274, for example formed as a bore on the flange 104 of the guide sleeve of the guide body 40, in the direction parallel to the pivot axis 22.

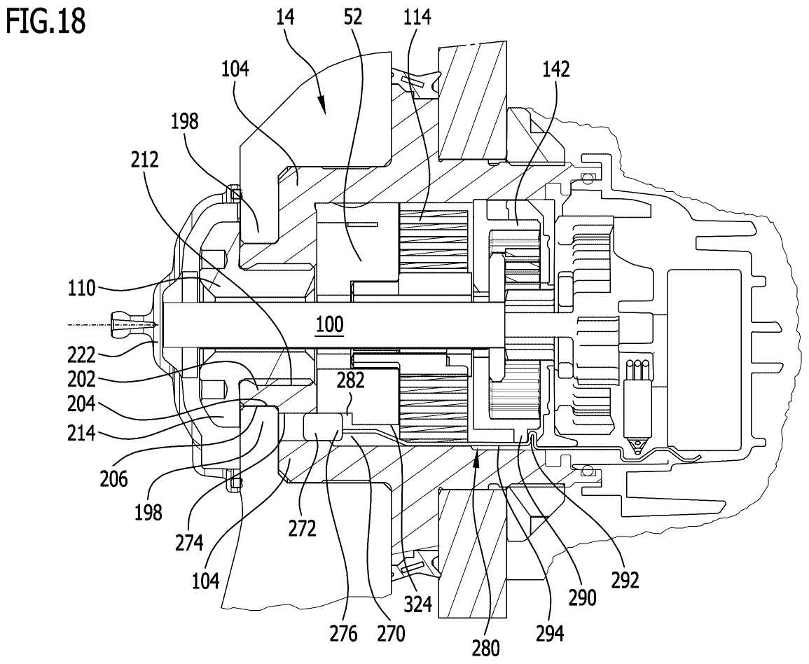

As shown in FIG. 18, the blocking body 272 is fixable in such a way that, in a securing position, it is able, with an end 276 facing the actuating body 52, to engage, starting from the guide 274, in a receptacle of the actuating body 52 when the latter is in the rotation blocking position and thus fixes the pivot bearing body 14 and the guide body 40 relative to one another.

The actuating body 52 assumes this rotation blocking position both in the working position and in the rest position, so that both the working position and the rest position are additionally secured by the actuating body 52, although the actuating body is already acted upon in the direction of the rotation blocking position due to the action of the torsion spring 114.

Furthermore, starting from the securing position, the blocking body 272 is moveable into a standby position, in which it no longer engages with the end 276 in the recess 282 of the actuating body 52, but is preferably positioned within the extent of the flange 104 in the direction parallel to the pivot axis 22.

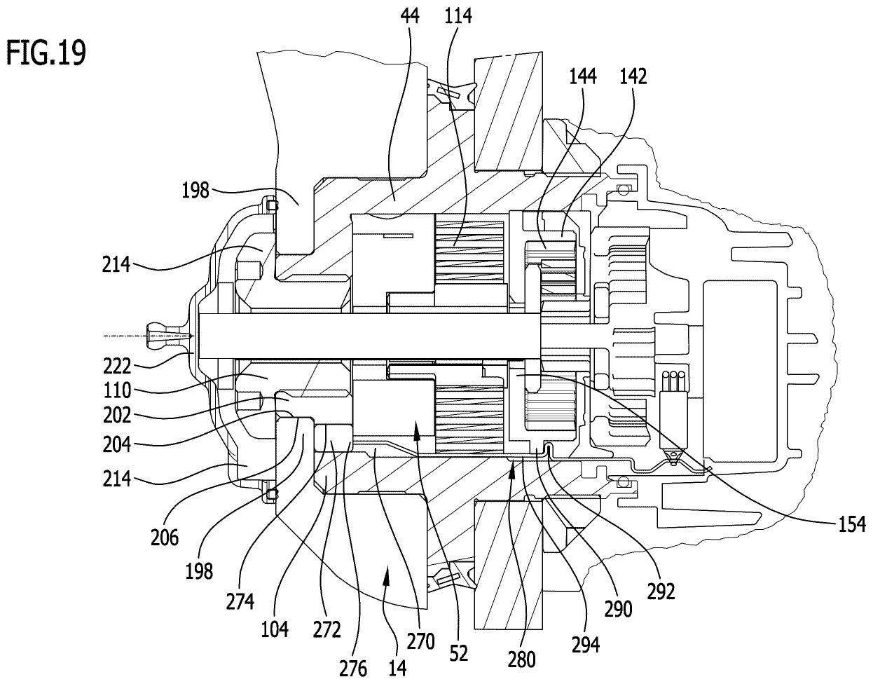

In this case, the blocking body 272 remains in the standby position without a blocking effect and is preferably also positioned within the extent of the flange 104, as shown in FIG. 19.

To move the blocking body 272 between the standby position and the securing position, an actuating device 280 is provided, which is coupled to the actuating unit 180 for the rotation blocking device.

The actuating device 280 comprises a camming guide designated as a whole by 290, wherein the camming guide 290 acts on a cam follower 292, which in turn acts on a transmission element 294 coupled to the blocking body 272, so that the blocking body 272 is thereby moveable into the securing position and into the standby position.

Preferably, the camming guide 290 is arranged on the circumferential side of the ring gear 142 of the actuating unit 180, which is part of the planetary gearing 130, which on the one hand serves to drive the actuating body 52 of the rotation blocking device 50 by means of the drive sleeve 122.

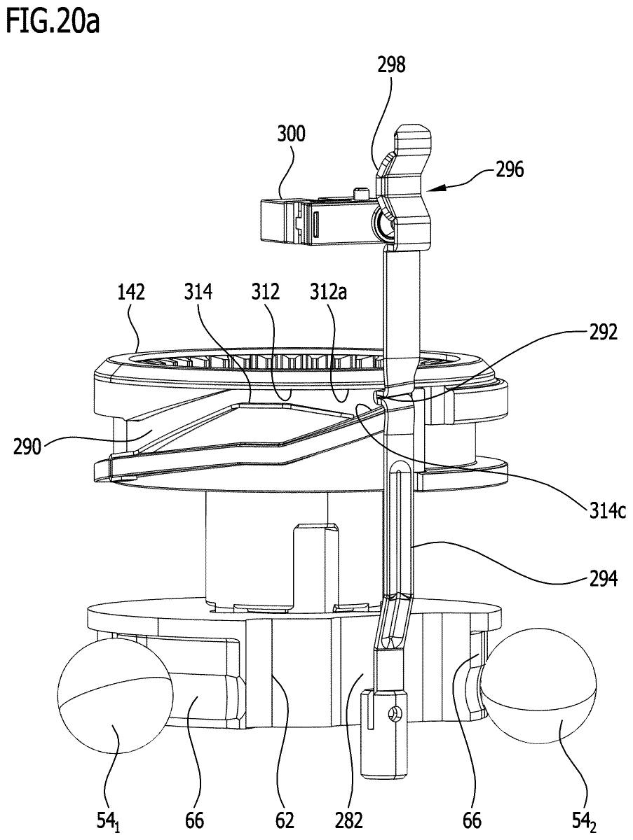

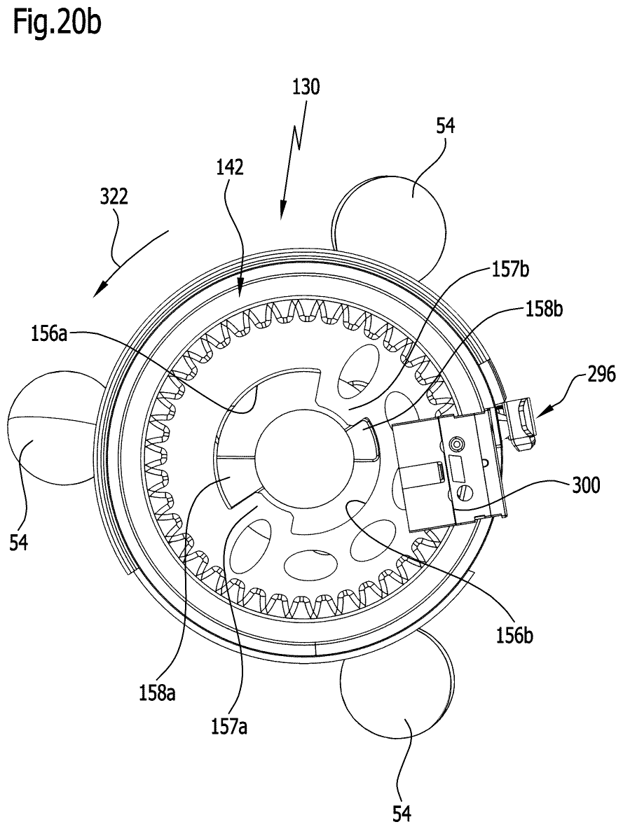

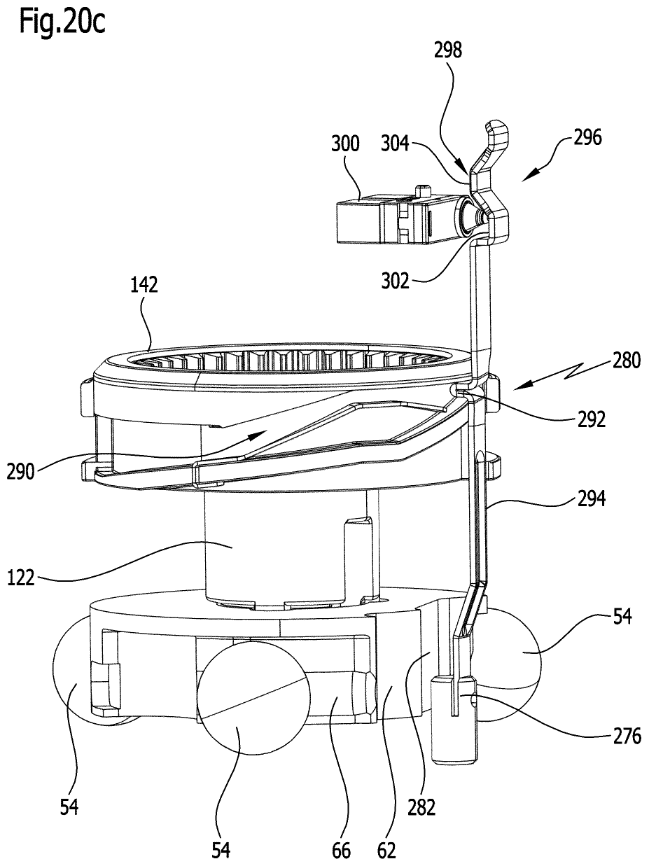

As shown in FIG. 20, in particular FIG. 20a, the actuating body 52 is positioned in the rotation blocking position of the rotation blocking device 50 in such a way that it acts on the rotation blocking bodies 54 in the radial direction relative to the pivot axis 22 and moves them in the guide direction 58 into the receptacles provided, in order thus to fix the pivot bearing body 14 non-rotatably relative to the pivot axis 22 either in the working position A or in the rest position R.

For this purpose, the pushing surfaces 66 of the actuating body act in particular on the rotation blocking bodies 54, shown in FIG. 20a.

For example, the recess 282, in which the blocking body 272 engages with its first end 276 to secure the rotary position of the actuating body 52, lies between the retraction receptacle 62 of one of the rotation blocking bodies 54₁ and a pushing surface 66 of a rotation blocking body 54₂ following next in the circumferential direction.

Furthermore, as shown in FIG. 20a, the camming guide 290 comprises camming paths 312 and 314 which are arranged facing each other on the circumferential side of the ring gear 142 and which, for positioning the cam follower 292 in the securing position of the blocking body, extend with positioning portions 312a and 314f relative to each other in such a way that the cam follower 292 is positioned exactly between these positioning portions 312a and 314c of the two camming paths 12 and 14 in the securing position and thus in a defined manner and has no possibility whatsoever, for example in the direction parallel to the pivot axis 22, to move into the standby position, but remains fixed in the securing position, so that by this precisely defined positioning of the cam follower 292 the transmission element 294 positions the blocking body 272 non-displaceably in the securing position and thus additionally secures the actuating body 52.

Furthermore, as shown in FIG. 20c, the transmission element 294 extends to a sensor actuating element 296, which actuates a sensor 300 during the movement of the transmission element 294 by means of a position indicating element 298 movable relative to the sensor 300, wherein the position indicating element 298 has a first sensing surface 302 and a second sensing surface 304 in the illustrated case of a sensor 300 formed as a pushbutton.

For example, the first sensing surface 302 is used to detect the secured position and the second sensing surface 304 is used to detect the standby position, wherein the sensing surfaces 302 and 304 are used to actuate the sensor 300 to different degrees.

However, the sensor 300 can also be a magnetic field sensor that detects differently magnetized regions of the position indicating element 298.

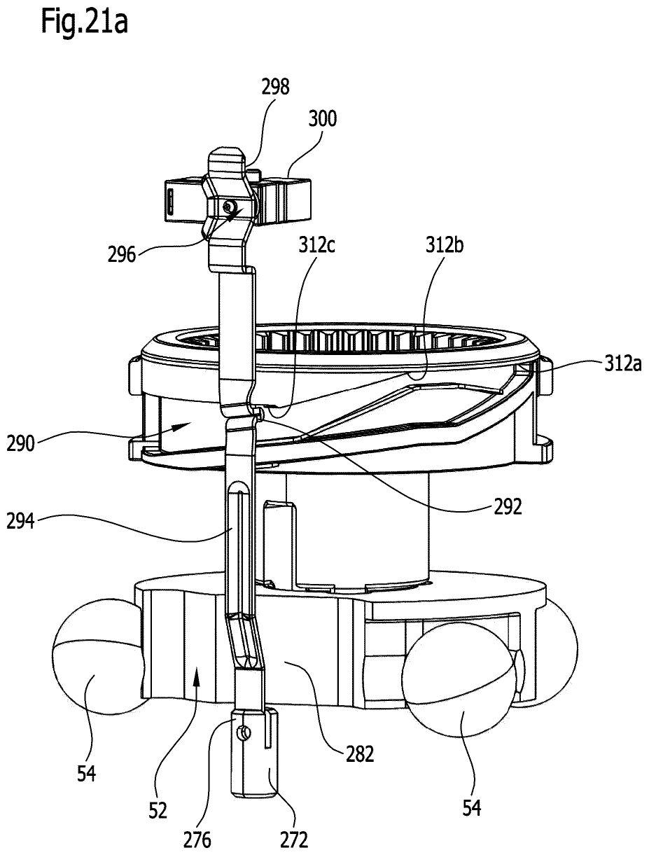

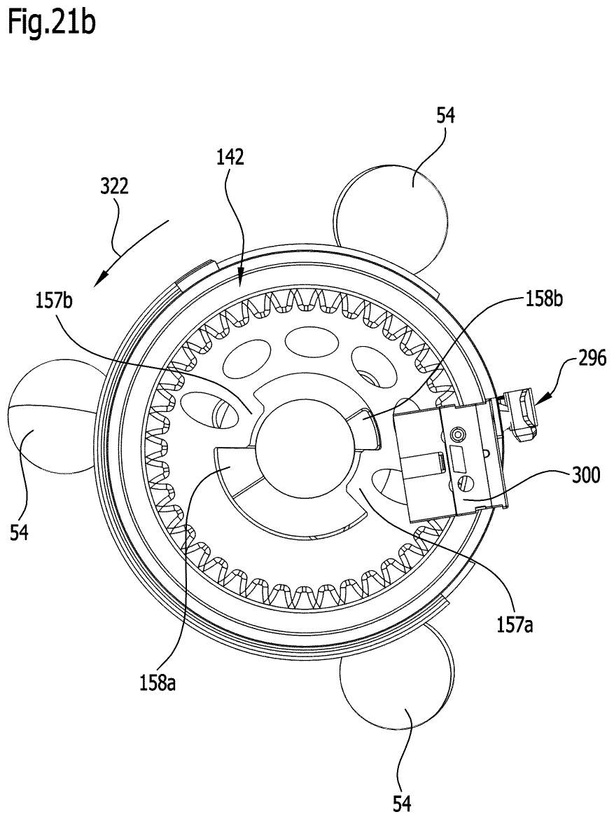

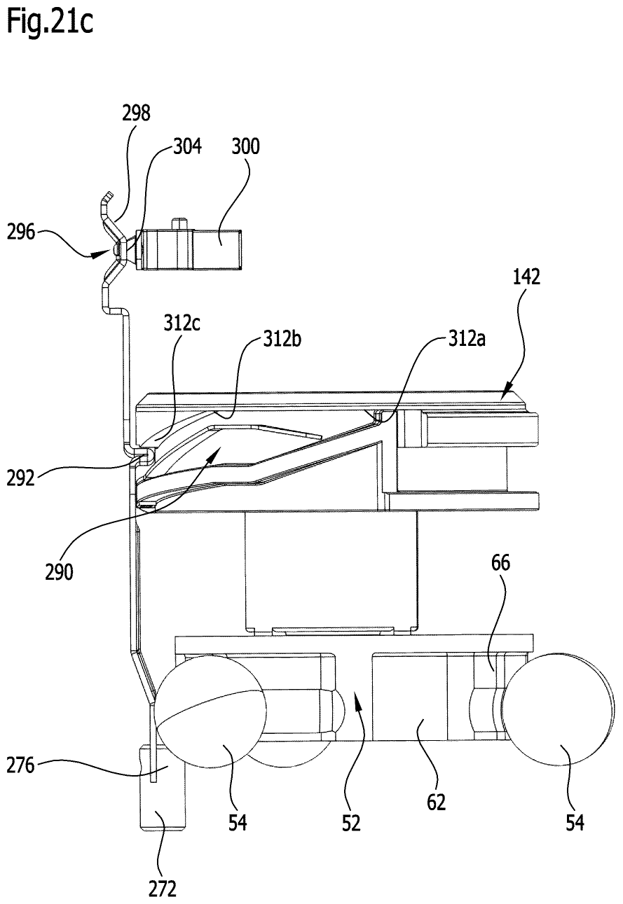

As also shown in FIG. 20b, in the starting position of the ring gear 142 of the planetary gearing 130, the drive fingers 158a and 158b engaging in drive slots 156a and 156b are in contact with the drive webs 157a and 157b separating the drive slots 156a and 156b, in such a way that driving of the ring gear 142 in the rotational direction 322 initially does not cause the drive fingers 158a and 158b to be driven, since the ring gear 142 moves in the rotational direction 322 in which the drive webs 157a and 157b move away from the drive fingers 158a and 158b, as shown in FIG. 21b.

This in turn results in the cam follower 292 moving along an ejection portion 312b of the camming guide 290, as shown in FIG. 21a, which displaces the cam follower 292 in the direction of the blocking body 272 and thus moves the blocking body 272 with the end 276 out of the receptacle 282 of the actuating body 52 and assumes the standby position shown in FIG. 21a when the positioning portion 312c is reached.

Since the blocking body 272 cannot move beyond the standby position in the guide 274 due to the end flange 198 of the pivot bearing body 14, the positioning portion 312c together with the end flange 198 holds the blocking body 272 in the standby position, as shown in FIG. 21a.

In this standby position, predetermined by the positioning section 312c, the sensor actuating element 296 was also moved relative to the sensor 300 due to the transmission element 294, so that the latter is now acted upon by the sensing surface 304 and recognizes that the standby position has been reached.

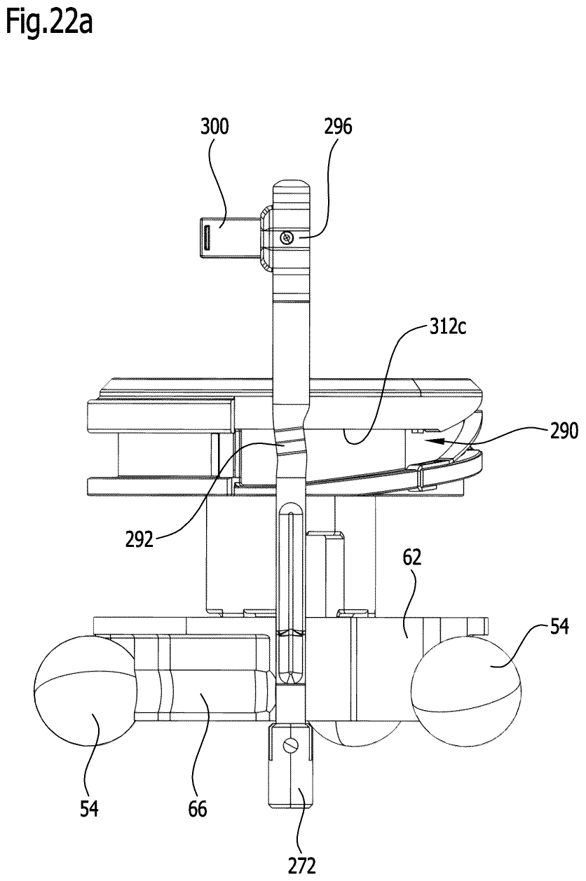

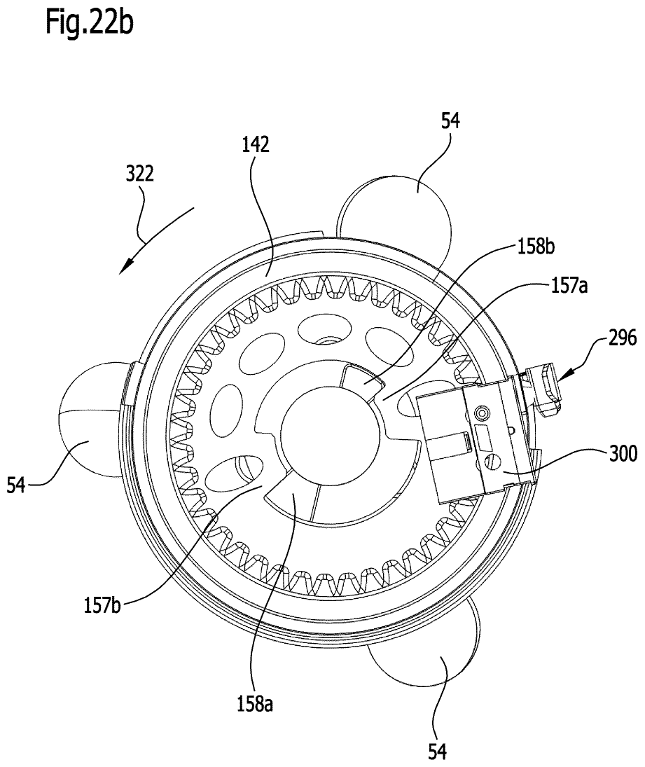

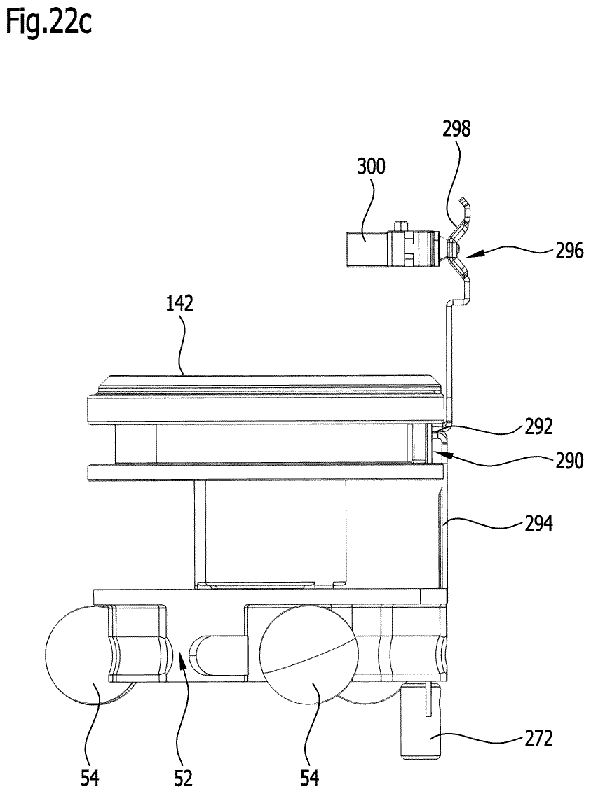

In this standby position, the actuating body 52 is unlocked, so that now a further rotation of the ring gear 142 has the effect that the drive webs 157b and 157a cause the drive fingers 158a and 158b to depart from their contact with the drive fingers 158a and 158b, so that now, as shown in FIG. 22b, a further rotation of the ring gear 142 in the rotational direction 322 leads to a release of the rotation blocking position, since the actuating body 52 is moved against the force of the torsion spring 114 from the rotation blocking position into the release position.

In this case, the cam follower 292, as shown in FIG. 22c, continues to move on the positioning portion 312c and, as already described, holds the blocking body 272 in the standby position, wherein the rotation blocking bodies 54 in this case are in their release position.

Already with the first release of the rotation blocking position, the ball neck 14 has the possibility to leave the working position or rest position due to the effect of gravity and thus to pivot out of the working position or rest position in the direction of the path into an intermediate position, wherein due to the arrangement of the working position receptacles 60A and the rest position receptacles 60R as well as the rotation blocking bodies 54, which are prevented from moving from the release position to the rotation blocking position in the intermediate positions between these, the rotation blocking bodies 54 have no possibility of leaving the release position before reaching the working position or the rest position.

Starting from the working position or rest position, it is therefore usually to be expected that the user of the trailer coupling will move the ball neck 14 from its position hanging downwards in the direction of gravity towards the rest position or working position.

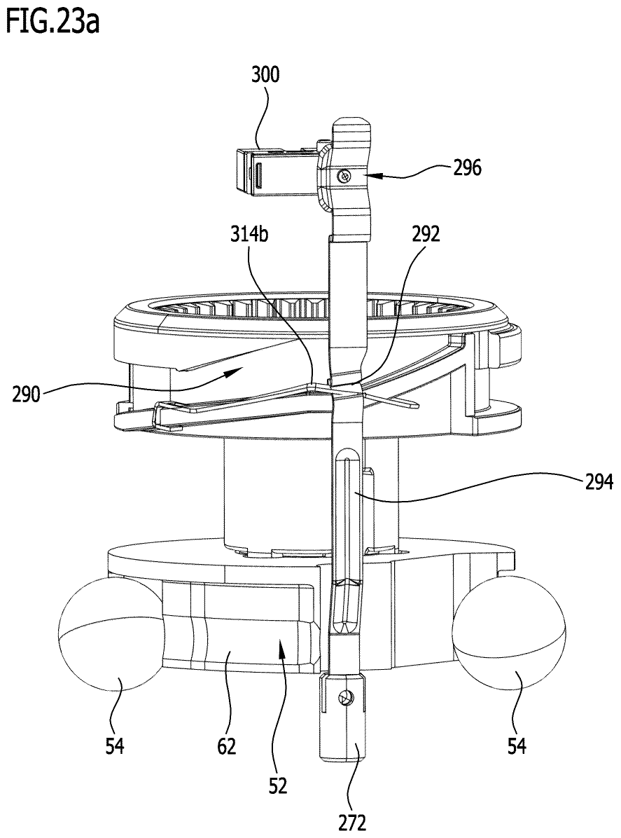

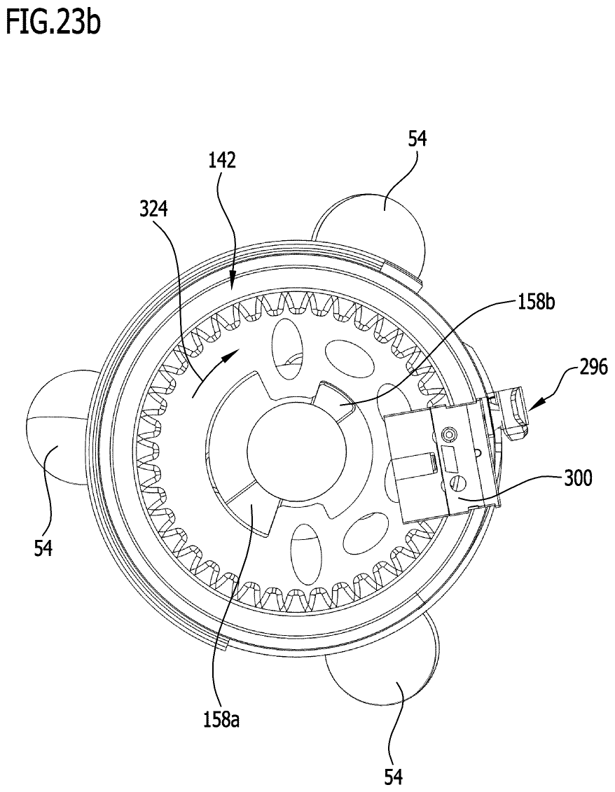

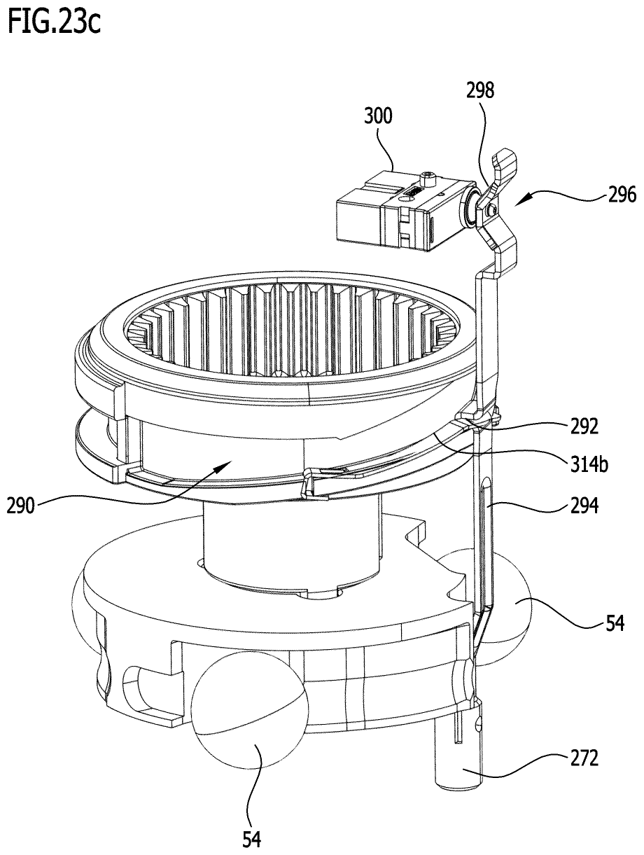

When the positioning portion 312c is reached, the drive of the actuating unit 180 has therefore already changed the rotational direction and rotated the ring gear 142 back in the rotational direction 324 opposite to the rotational direction 322 to such an extent that the cam follower 292 is acted upon by a resilient ejection portion 314b of the camming path 314, which acts on the path follower 292 in the direction of the securing position, but cannot yet move the path follower 292 into the securing position, since the blocking body 272 is prevented from moving into the rotation blocking position by the still existing release position of the actuating body 52, as shown in FIGS. 23a and 23c.

In FIGS. 23a to 23c, the ball neck 10 is not yet in the intended end position, that is, for example, the working position or the rest position, since the rotation blocking device 50 is still in the release position and has not had the chance to move to the rotation blocking position.

On the other hand, in this position, the cam follower 292 is resiliently loaded in the direction of the securing position by the resilient ejection portion 314b, but cannot yet move into the securing position, since the actuating body 52 is also still in the release position.

In addition, the motor can only rotate the ring gear 142 back into the aforementioned position, since further rotation of the ring gear 142 in the rotational direction 324 by the drive fingers 158a and 158b, which are coupled to the rotational position of the actuating body 52, prevents it from rotating further back in the direction of the starting position.

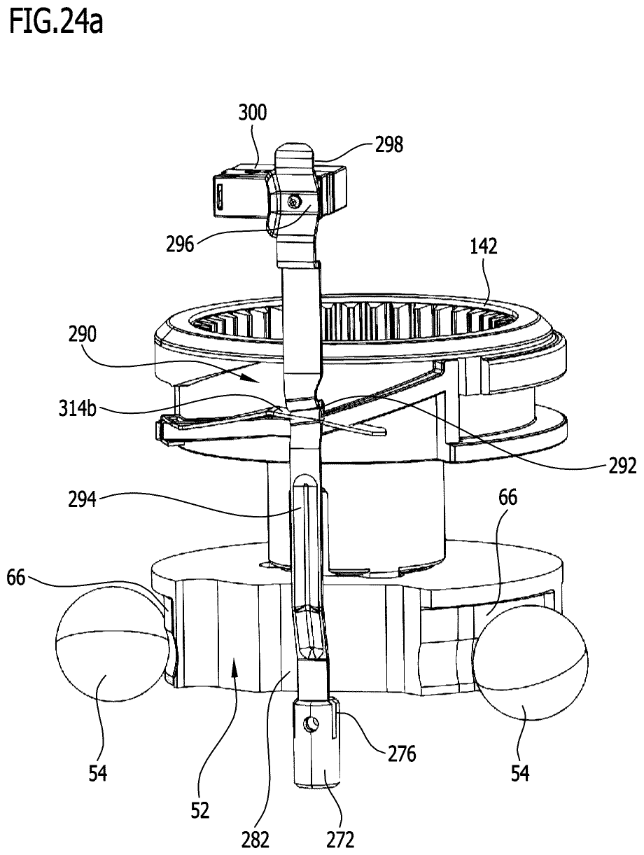

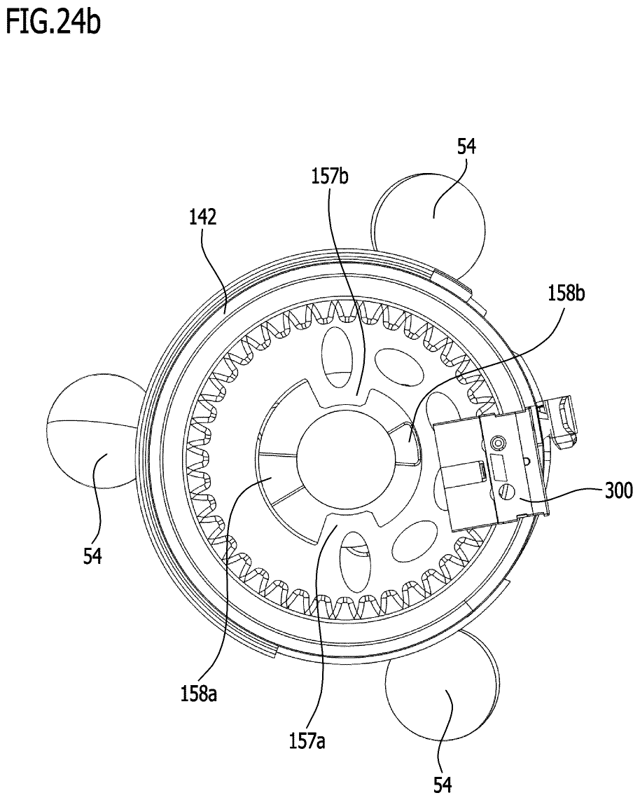

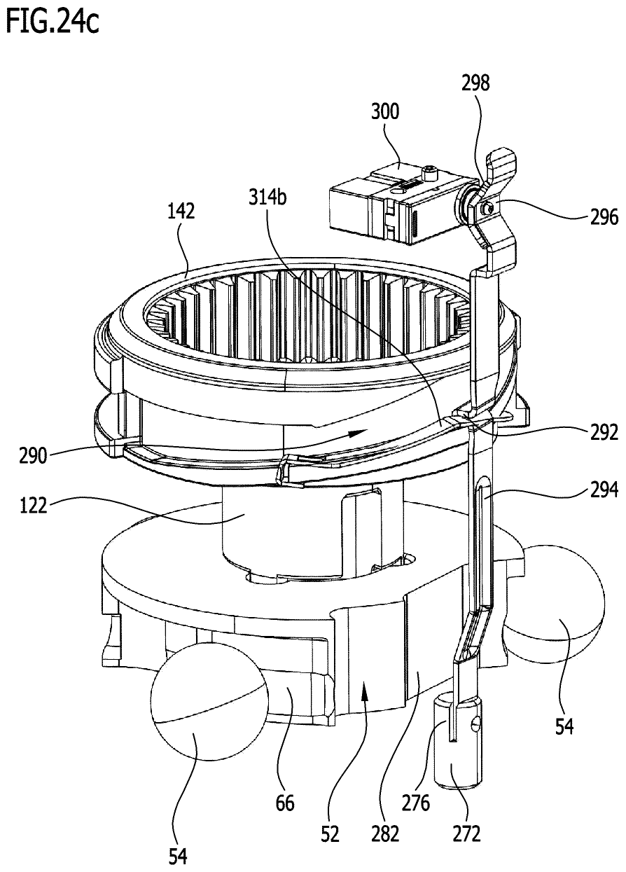

Only when the manually initiated pivoting movement of the ball neck 14 has caused it to reach the rest position or working position can the actuating body 52, acted upon by the torsion spring 114, move from the release position to the rotation blocking position, and in this position the drive sleeve 122 with the drive fingers 158a and 158b is in the position corresponding to the rotation blocking position, as shown in FIG. 24a, since the rotation blocking bodies 54 are acted upon by the pushing surfaces 66 and are thus displaced radially in the direction of their rotation blocking position.

This rotation blocking position of the actuating body 52 now allows the elastically acting ejection portion 314b to act on the cam follower 292 in such a way that the latter pushes the blocking body 272 with the end 276 into the receptacle 282 in the actuating body 52 into the securing position and thus secures the actuating body 52 in addition to the torsion spring 114, which acts on the actuating body 52 in this position in any case.

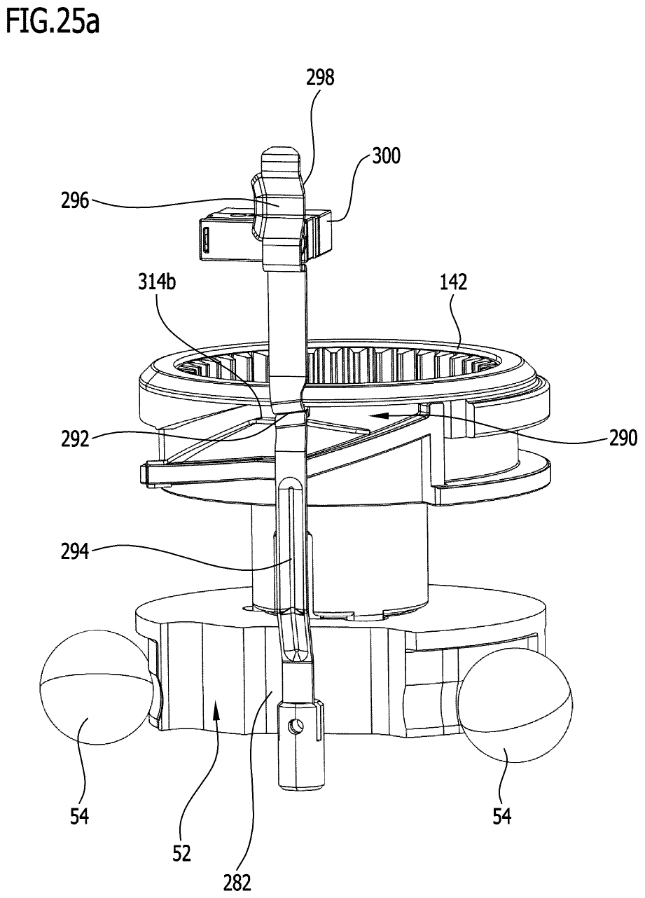

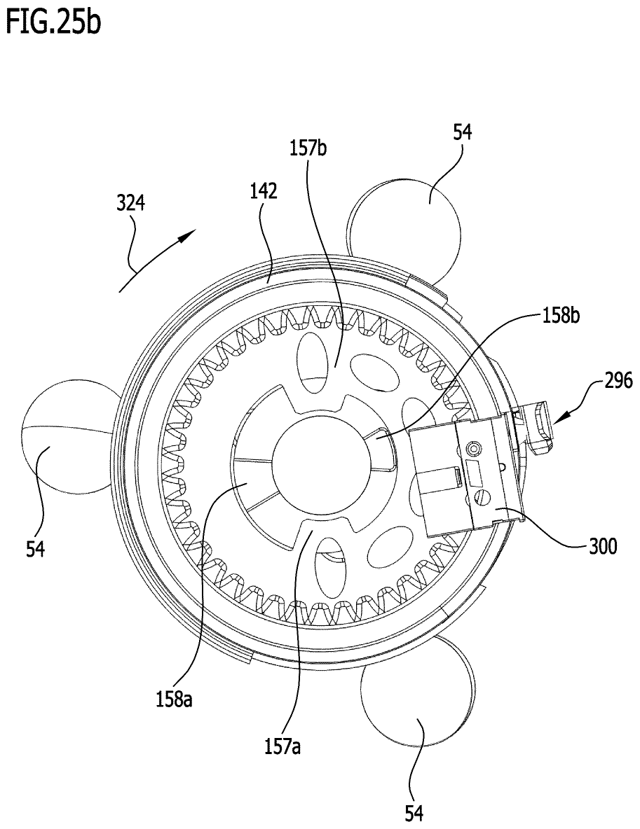

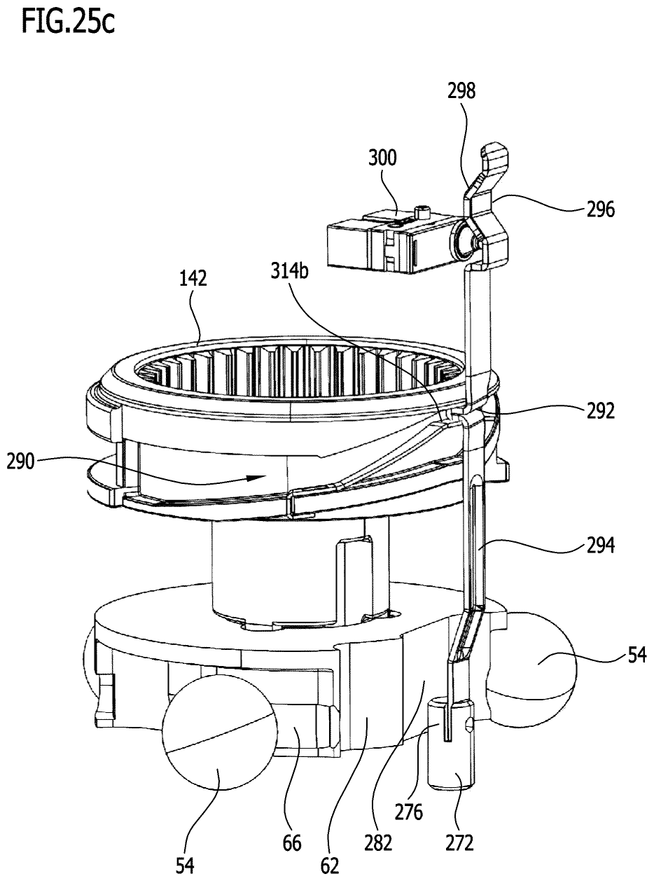

This means that the blocking body 272 now engages in the receptacle 282 starting from the position in FIGS. 24a and 24c and, as shown in FIG. 25a, secures the actuating body 52 in the rotation blocking position.

In this case, the sensor actuating element 296 with the position indicating element 298 acts on the sensor 300 in such a way that the latter now detects the secured position of the blocking body 272.

In this case, however, as shown in FIG. 25b, the ring gear 142, which is driven solely by the drive motor, is still in a rotational position that does not yet correspond to the final starting position.

For this reason, a short drive signal for the drive motor is triggered by the sensor 300, which leads to the drive motor being rotated further in the direction 324 and thus the cam follower 292 again reaching the rotational position shown in FIG. 20a-c, in which the drive webs 157a and 157b are again in contact with the drive fingers 158a and 158b.

Furthermore, in this rotational position, as can be seen in FIG. 20a and FIG. 20c, the cam follower 292 is permanently and reliably positioned by the two positioning portions 312a and 314c in a position in which the blocking body 272 cannot leave the securing position.

1. A trailer coupling comprising a ball neck, which is movable between a working position and a rest position and which is connected at a first end to a pivot bearing unit and carries a coupling ball at a second end, wherein the ball neck is pivotable about a pivot axis between the working position and the rest position by way of the pivot bearing unit in order to execute a pivoting movement, and a rotation blocking device acting between a guide body and a pivot bearing body of the pivot bearing unit and having at least two rotation blocking units, each of which has a rotation blocking body, which is guided movably in a guide direction by way of a guide receptacle of the guide body and which is movable in the guide direction by a pushing surface extending transversely to the guide direction and provided on an actuating body, wherein the rotation blocking bodies of all rotation blocking units are configured to be moved and acted upon in the guide direction by a movement of the actuating body in an actuating direction, and wherein the rotation blocking bodies of all rotation blocking units in the working position or the rest position are configured to be brought into a rotation blocking position by movement in the guide direction and in this rotation blocking position each rotation blocking body comes into engagement with one of the at least two working position receptacles or one of the at least two rest position receptacles, in order to block a pivoting movement of the pivot bearing body and the guide body relative to one another about the pivot axis, and wherein the rotation blocking bodies are configured to be brought into a release position and in this position are disengaged from the respective working position receptacle or the respective rest position receptacle and release the pivoting movement between the pivot bearing body and the guide body,
wherein in all provided relative pivot positions between the pivot bearing body and the guide body, apart from the working position and the rest position, a movement of the actuating body in the actuating direction and consequently also a force-loaded engagement of the rotation blocking bodies of each of the rotation blocking units into one of the working position receptacles or the rest position receptacles is blocked, wherein a blocking device is provided which comprises a blocking body is moveable into a securing position securing the actuating body in the rotation blocking positions and a standby position lying outside the securing position.

2. The trailer coupling in accordance with claim 1, wherein the blocking body is guided on the guide body of the pivot bearing unit.

3. The trailer coupling in accordance with claim 1, wherein the blocking body is guided in a guide arranged on the guide body, wherein in particular the guide is arranged in a wall region of the guide body adjacent to the actuating body, and wherein in particular the wall region is arranged between the actuating body and the pivot bearing body.

4. The trailer coupling in accordance with claim 3, wherein the blocking body is movable in the guide in a direction approximately parallel to the pivot axis.

5. The trailer coupling in accordance with claim 1, wherein the blocking body in the respective securing position engages in a receptacle in the actuating body.

6. The trailer coupling in accordance with claim 1, wherein the blocking body in the standby position is positioned adjacent to the actuating body.

7. The trailer coupling in accordance with claim 1, wherein the guide for the blocking body is arranged in a wall region of the guide body adjacent to the actuating body.

8. The trailer coupling in accordance with claim 3, wherein the blocking body in the securing position, starting from and guided by the guide, engages in each case with one end in the respective receptacle of the actuating body.

9. The trailer coupling in accordance with claim 1, wherein the blocking body is fixable in the securing position by an actuating device.

10. The trailer coupling in accordance with claim 9, wherein the actuating device comprises a camming guide and a cam follower which is moveable by the latter and which is coupled to the blocking body.

11. The trailer coupling in accordance with claim 10, wherein the cam follower is movable by the camming guide approximately parallel to the pivot axis.

12. The trailer coupling in accordance with claim 10, wherein the camming guide is movable in a plane transverse to the pivot axis.

13. The trailer coupling in accordance with claim 10, wherein the camming guide is movable by an actuating device.

14. The trailer coupling in accordance with claim 13, wherein the actuating device comprises a body carrying the camming guide and movable in rotation relative to the cam follower.

15. The trailer coupling in accordance with claim 10, wherein the camming guide has at least one camming path acting on the cam follower.

16. The trailer coupling in accordance with claim 10, wherein the camming guide has two camming paths acting on the cam follower and guiding it between them.

17. The trailer coupling in accordance with claim 16, wherein both camming paths together fix the cam follower in a position predetermining the securing position.

18. The trailer coupling in accordance with claim 16, wherein a first camming path comprises a path portion moving the cam follower from the position defining the securing position to a position defining the standby position.

19. The trailer coupling in accordance with claim 16, wherein a second camming path comprises a path portion which moves the cam follower from the position corresponding to the standby position to a position resiliently loading the cam follower towards the securing position.

20. The trailer coupling in accordance with claim 16, wherein the first camming path is effective by a movement of the camming guide in a first rotational direction, and wherein the second camming path is effective by a movement of the camming guide in a rotational direction opposite to the first rotational direction.

21. The trailer coupling in accordance with claim 20, wherein the actuating device is drivable by an actuating unit for the rotation blocking device.

22. The trailer coupling in accordance with claim 21, wherein the actuating device is coupled to the actuating unit.

23. The trailer coupling in accordance with claim 21, wherein the camming path is arranged on a rotatable body of a planetary gearing of the actuating unit for the rotation blocking device.

24. The trailer coupling in accordance with claim 23, wherein the camming path is arranged on a ring gear of a planetary gearing of the actuating unit.

25. The trailer coupling in accordance with claim 1, wherein the blocking device comprises a sensor detecting the positions of the blocking body.

26. The trailer coupling in accordance with claim 25, wherein the sensor detects the securing position and the standby position.

27. The trailer coupling in accordance with claim 9, wherein the cam follower is coupled to the blocking body by way of a transmission element.

28. The trailer coupling in accordance with claim 27, wherein the transmission element is coupled to a sensor actuating element.

29. The trailer coupling in accordance with claim 1, wherein blocking surfaces extend between the working position receptacles and the rest position receptacles, against which blocking surfaces the rotation blocking bodies are placeable and from which the working position receptacles and the rest position receptacles extend, wherein the rotation blocking units and the working position receptacles and the rest position receptacles are arranged around the pivot axis at angular spacings from one another in such a way that, in all provided pivot positions of the pivot bearing body and of the guide body relative to one another, apart from the working position and the rest position, the rotation blocking body of at least one of the rotation blocking units is opposite one of the blocking surfaces and thus these blocking surfaces, in particular when a force is applied to the actuating body in the direction of the actuating direction, block a movement of the actuating body in the actuating direction and consequently also a force-applied engagement of the rotation blocking bodies of each of the rotation blocking units in one of the working position receptacles or the rest position receptacles.

30. The trailer coupling in accordance with claim 1, wherein the rotation blocking units are arranged at angular spacings around the pivot axis to form a rotation blocking configuration, wherein the working position receptacles and the rest position receptacles are arranged at the same angular spacings around the pivot axis as the rotation blocking units in order to form respective receptacle configurations for the working position and the rest position, wherein the rotation blocking configuration and the receptacle configuration of the working position receptacle in the working position and of the rest position receptacles in the rest position are congruent with one another, so that the rotation blocking bodies can engage in the working position receptacles or rest position receptacles, and wherein the angular spacings between the rotation blocking units of the rotation blocking configuration and the angular spacings between the working position receptacles or the rest position receptacles of the receptacle configurations are selected such that the rotation blocking configuration and one of the receptacle configurations are congruent with one another only in the working position or the rest position.

31. The trailer coupling in accordance with claim 1, wherein the angular spacings of at least one of the rotation blocking units are unequal to the rotation blocking units arranged adjacent in a direction of revolution about the pivot axis and to the rotation blocking units arranged opposite to this direction of revolution, wherein in the working position the working position receptacles are arranged in such a way that the rotation blocking body of each of the rotation blocking units is configured to be brought into engagement with one of the working position receptacles, wherein in the rest position the rest position receptacles are arranged in such a way that the rotation blocking body of each of the rotation blocking units is configured to be brought into engagement with one of the rest position receptacles, and wherein in all pivot positions of the pivot bearing body and of the guide body relative to one another which are provided for operation and which lie outside the working position or the rest position, the rotation blocking body of at least one of the rotation blocking units is located opposite a blocking surface running between the working position receptacles and the rest position receptacles, and the blocking surface blocks a movement of the actuating body from the release position into the rotation blocking position, in particular when force is applied to the actuating body.

32.-60. (canceled)
